(19) United States
(12) Patent Application Publication
(10) Pub. No.: US 2012/0244043 A1
(43) Pub. Date: Sep. 27, 2012

(54) ELASTOMERIC GASKET FOR FLUID INTERFACE TO A MICROFLUIDIC CHIP

(76) Inventors: Sean Leblanc, Westminster, MA (US); Akim F. Lennhoff, Cambridge, MA (US); Bruce Neumann, Lexington, MA (US); Ali Aslam, Ayer, MA (US); Darren Link, Lexington, MA (US); Alfred Paris, Salzburg (AT); Gottfried Reiter, Salzburg (AT); Dario Borovic, Salzburg (AT); Christian Poeschl, Salzburg (AT)

(21) Appl. No.: 13/361,303

(22) Filed: Jan. 30, 2012

Related U.S. Application Data
(60) Provisional application No. 61/437,491, filed on Jan. 28, 2011.

(51) Int. Cl. B01L 3/00

(52) U.S. Cl. 422/504; 422/554

(57) ABSTRACT

The present invention relates to microfluidic devices that include a reliable seal between a substrate of the device and a fluid transport mechanism. The devices of the invention include at least one internal channel, and at least one port in fluid communication with the channel. A seal is associated with the port and is configured to receive a fluid transport mechanism. The seal is formed from an elastomeric material that is compatible for use with fluorinated oil and resists flaking and degradation.

### REFERENCE TO RELATED APPLICATIONS

This application claims priority to U.S. Provisional Application No. 61/437,491, filed Jan. 28, 2011, the contents of which are herein incorporated by reference in its entirety.

### TECHNICAL FIELD

The present invention relates to microfluidic systems. More specifically, the invention relates to gaskets for sealing fluid interfaces in microfluidic systems.

### BACKGROUND INFORMATION

Microfluidic devices are known. A microfluidic nozzle array device disclosed in U.S. Pat. No. 6,800,849 uses an O-ring sealing gasket. U.S. Pat. No. 7,390,463 also discloses the use of an O-ring, in connection with each of a plurality of microfluidic modules that together form a support structure or plate.

Precision manipulation of streams of fluids with microfluidic devices is revolutionizing many fluid-based technologies. Networks of small channels are a flexible platform for the precision manipulation of small amounts of fluids. Virtually all microfluidic devices are based on flows of streams of fluids. Current microfluidic technologies utilize aqueous droplets in an immiscible carrier fluid. Such droplets provide a well-defined, encapsulated microenvironment that eliminates cross contamination or changes in concentration due to diffusion or surface interactions. While significant advances have been made in dynamics at the macro- or microfluidic scale, improved fluid handling technology is still needed.

Microfluidic devices for performing biological, chemical, and diagnostic assays are described in U.S. Published Patent Application No. US2008/0003142 and US2008/0014589, each of which is incorporated by reference herein in its entirety. Such microfluidic devices generally include at least one substrate having one or more microfluidic channels etched or molded into the substrate, and one or more interconnects (fluid interface). The one or more interconnects contain inlet modules that lead directly into the microfluidic channels, and serve to connect the microfluidic channel to a means for introducing a sample fluid to the channel. The one or more interconnects also serve to form a seal between the microfluidic substrate and the means for introducing a sample. The one or more interconnects can be molded directly into the microfluidic substrate, as one or more individual pieces, or as a single, monolithic self-aligning piece (see e.g., FIGS. 11-13 of US2008/0003142, herein incorporated by reference in its entirety).

For pressure-driven microfluidic chips, it is essential to establish a reliable fluid interface. The mechanism(s) employed to introduce a sample fluid into the microfluidic channel, such as tubing or pipettes, is typically inserted in a simple linear motion, and it is important that a reliable seal be established in the first attempt to avoid sample contamination. The seal must be able to withstand and hold a pressure of at least 70 psi, the minimum pressure in most pressure-driven microfluidic devices. Furthermore, the seal component(s) must be suitable for use with both water and oil based fluids, given the trend in droplet technology towards the use of aqueous droplets in an immiscible carrier fluid (e.g., fluorinated oil).

### SUMMARY

The present invention relates to a microfluidic device that provides a reliable seal between a substrate of the device and the fluid transport mechanism which typically will be one or more pipettes, tubing, or other conduit providing a channel outside the microfluidic device. As used herein, the term “pipette(s)” is not intended to encompass only devices which require suction to draw fluids into them. Rather, the term “pipette(s)”, as used herein, includes any fluid carrier/conduit that is configured to carry a discrete amount of fluid for depositing into a microfluidic device. In particular, the present invention provides a microfluidic chip that utilizes a gasket at the fluid interface to the chip.

In one aspect, microfluidic chips according to the invention include a substrate member defining at least one internal channel and at least one port in fluid communication with the channels. In one particular embodiment, the substrate member includes a top plate adhered to a bottom plate to form the substrate with the channel(s) and port(s). The top and bottom plates each include a top surface and a bottom surface. The top surface of the bottom plate faces and is adhered to the bottom surface of the top plate. The top plate can include the port(s), and the bottom plate can include the channel(s), such that when these two plates are brought together and adhered to each other the combination forms the substrate with the channel(s) and the port(s). Alternatively, the top plate can include the channel(s), and the bottom plate can include the port(s), such that when these two plates are brought together and adhered to each other the combination forms the substrate with the channel(s) and the port(s). Microfluidic chips of the invention further include an elastomeric gasket associated with each of the ports and configured to sealingly receive a fluid transport mechanism (e.g., a pipette or a tubing) into the port, such that fluid from the fluid transport mechanism enters the channel via the port that leads to that channel. At least a portion of the gasket fits at least partially into the port, while another portion of the gasket sealingly receives the fluid transport mechanism. When the fluid transport mechanism contacts the gasket, that contact creates radial compression against the gasket to form a fluid-tight seal against the port.

Preferably, the gasket is made from a material suitable for use with a fluorinated oil, and that resists flaking and degradation after sealingly receiving the fluid transport mechanism. In certain aspects, the gasket is made from a thermoplastic silicone elastomer, for example, by injection molding. In a particular embodiment, the gasket is made from Genomier® 200.

The elastomeric gaskets are capable of establishing a fluid-tight seal by the simple linear motion of a pipette being placed into contact with the gasket. The radial compression caused by insertion of the pipette into the gasketed port (and/or the chip with its gasketed port can be moved toward the pipette) is sufficient to seal the gasket against the port and allow fluid to exit the pipette and enter the channel without any leakage of the fluid (or the fluid can be pulled from the channel and into the pipette, also without any leakage of fluid). The seal created by the elastomeric gaskets described herein can withstand and hold pressure up to 100 psi, thereby providing a tight and complete seal which eliminates, or at least significantly minimizes, the risk of contamination of the sample fluid.

In another aspect, microfluidic chips according to the invention include a substrate member defining at least three internal channels and also defining a first inlet port and first outlet port of a first one of the channels, a second inlet port and a second outlet port of a second one of the channels, and a third inlet port and a third outlet port of a third one of the channels. The substrate member includes a top plate adhered to a bottom plate to form the substrate with the channel(s) and port(s). The top and bottom plates each include a top surface and a bottom surface. The top surface of the bottom plate faces and is adhered to the bottom surface of the top plate. The top plate can include the port(s), and the bottom plate can include the channel(s), such that when these two plates are brought together and adhered to each other the combination forms the substrate with the channel(s) and the port(s). Alternatively, the top plate can include the channel(s), and the bottom plate can include the port(s), such that when these two plates are brought together and adhered to each other the combination forms the substrate with the channel(s) and the port(s).

The microfluidic chip further includes a first gasket associated with the first, second and third inlet ports and configured to sealingly receive a fluid input mechanism (e.g., a pipette or tubing) such that fluid from the fluid input mechanism enters one of the first, second and third channels via one of the first, second and third inlet ports, and a second gasket associated with the first, second and third outlet ports and configured to sealingly receive a fluid output mechanism (e.g., a pipette or tubing) such that fluid exits one of the first, second and third channels via one of the first, second and third outlet ports and enters the fluid output mechanism.

The first gasket includes a first, a second, and a third bottom portion, each of which fits at least partially into the first, second and third inlet ports, respectively. The first gasket further includes a first, a second and a third top portion, each of which sealingly receives the fluid input mechanism to allow fluid that exits the fluid input mechanism to enter the first, second and third channels, respectively.

The second gasket includes a first, a second, and a third bottom portion, each of which fits at least partially into the first, second and third outlet ports, respectively. The second gasket further includes a first, a second and a third top portion, each of which sealingly receives the fluid output mechanism to allow fluids that exit the first, second and third channels to enter the fluid output mechanism.

The first gasket, the second gasket, or both, are preferably made from a material that is suitable for use with a fluorinated oil and resists flaking and degradation after sealingly receiving the fluid input and output mechanisms. In certain aspects, the first and/or second gaskets are made from a thermoplastic silicone elastomer, for example, by injection molding. In a particular embodiment, at least a portion of the first and/or second gaskets are made from Genomier® 200.

In certain aspects, the microfluidic chips of the invention are housed within a carrier.

These and other aspects of the invention are described in further detail in the Figures and Detailed Description below.

### BRIEF DESCRIPTION OF THE DRAWINGS

Non-limiting embodiments of the present invention will be described by way of example with reference to the accompanying drawings, which are schematic and are not intended to be drawn to scale. In the drawings, each identical or nearly identical component illustrated is typically represented by a single numeral. For the purposes of clarity, not every component is labeled in every drawing, nor is every component of each embodiment of the invention shown where illustration is not necessary to allow those of ordinary skill in the art to understand the invention. In the drawings:

FIG. 1 depicts an exemplary embodiment a gasket interface disposed between a microfluidic chip/plate and a fluid transport mechanism (e.g., pipette).

FIG. 2 depicts a cross-section of a microfluidic chip/plate that includes one or more port structures that include a tapered lead directly in a microfluidic channel (reference 1), and a gasket that contains matching tapered bosses configured to fit within the port structures (reference 2).

FIG. 3 depicts the assembly of the gasket and fluidic chip/plate shown in FIG. 2.

FIG. 4 depicts the use of a pipette tip to position and seal the gasket depicted in FIGS. 2 and 3 within the port.

FIG. 5 is a general schematic of an exemplary embodiment of a fluidic chip according to the invention, showing the general location of various port modules for use with a microfluidic chip according to the invention; FIGS. 5A and 5B depict cross-sections of the fluidic chip shown in FIG. 5A; FIGS. 5C-5H depict enlarged details of the different port modules shown in FIGS. 5A and 5B.

FIG. 6A depicts a cross-section of a microfluidic chip according to the invention that includes a top plate and a bottom plate, and a gasket overmolded directly onto the top plate; FIG. 6B depicts a three-dimensional perspective of the various layers and components contained within a microfluidic chip that includes one or more gaskets overmolded directly onto the top plate

FIG. 7A depicts a three-dimensional perspective of the various layers and components contained within a microfluidic chip that includes one or more gaskets molded into pockets within the top plate; FIG. 7B depicts an exploded view of the microfluidic chip of FIG. 7A, showing a top plate with pockets, the gaskets that are molded into the pockets, and a bottom plate that is adhered to the top plate; FIG. 7C depicts an enlarged cross-section of a gasket molded into a pocket of the top plate; FIG. 7D depicts a sideways perspective of the microfluidic chip depicted in FIG. 7A.

FIG. 8A depicts a front/top perspective of an exemplary embodiment of a gasket interface for use with a microfluidic chip according to the invention; FIG. 8B depicts a side perspective of the gasket depicted in FIG. 8A; FIG. 8C depicts a cross-section of the gasket interface depicted in FIG. 8A.

FIG. 9A depicts a cross-section of the fluid interface with an exemplary microfluidic chip using the gasket shown in FIG. 8A; FIG. 9B is an enlarged perspective of the fluid interface shown in FIG. 9A.

FIG. 10A depicts a front/top perspective of an exemplary embodiment of a gasket/chip/carrier assembly according to the invention; FIG. 10B depicts a cross-section of a portion of the gasket/chip/carrier assembly depicted in FIG. 10A; FIG. 10C depicts an enlarged perspective of a portion of the gasket/chip/carrier shown in FIG. 10B.

FIG. 11A depicts a front/top perspective of an exemplary embodiment of a gasket/chip/carrier assembly according to the invention; FIG. 11B depicts a back/bottom perspective of the gasket/chip/carrier assembly shown in FIG. 11A; FIG. 11C depicts an enlarged perspective of a portion of the gasket/chip/carrier shown in FIG. 11B.

FIG. 12A depicts a front/top perspective of an exemplary embodiment of a gasket/chip/carrier assembly according to the invention; FIG. 12B depicts a back/bottom perspective of the gasket/chip/carrier shown in FIG. 12B.

FIGS. 13A and 13B depict front perspectives of exemplary embodiments of a gasket/chip/carrier assembly according to the invention.

FIG. 14A depicts a front/top perspective of an exemplary embodiment of a gasket/chip/carrier assembly according to the invention; FIGS. 14B and 14C depict different cross-sections of the gasket/chip/carrier assembly shown in FIG. 14A; FIG. 14D depicts an enlarged detail of a portion of FIG. 14B; FIG. 14E depicts an enlarged detail of a portion of FIG. 14C.

FIG. 15A depicts a front/top perspective of an exemplary embodiment of a gasket/chip/carrier assembly according to the invention; FIG. 15B depicts an enlarged detail of a portion of FIG. 15A.

FIG. 16A depicts a schematic of an exemplary embodiment of a gasket/chip/carrier assembly according to the invention; FIGS. 16B-16E depict enlarged details of portions of FIG. 16A.

FIG. 17 illustrates possible interconnect designs for use with PDMS devices.

FIG. 18 illustrates self-alignment of a fluidic interconnect

FIG. 19 illustrates the interconnects needed for each tube molded into a single monolithic self-aligned part.

FIG. 20 shows a schematic of a molding tool based on this concept. The pins are captured within an elastomeric molded sleeve and a compression plate made from a rigid backer plate and foam rubber is used to apply gentle even pressure to the pins and generate the force needed to make the pins uniformly contact the master.

### DETAILED DESCRIPTION

The microfluidic devices and methods of use described herein are based on the creation and manipulation of aqueous phase droplets completely encapsulated by an inert immiscible oil stream. This combination enables precise droplet generation, highly efficient, electrically addressable, droplet coalescence, and controllable, electrically addressable single droplet sorting. The microfluidic devices include one or more channels and modules. The integration of these modules is an essential enabling technology for a droplet based, high-throughput microfluidic reactor system.

The microfluidic devices of the present invention can be utilized for numerous biological, chemical, or diagnostic applications, as described in further detail herein.

### Substrates

The microfluidic device of the present invention includes one or more analysis units. An “analysis unit” is a micro substrate, e.g., a microchip. The terms microsubstrate, substrate, microchip, and chip are used interchangeably herein. The analysis unit includes at least one inlet channel, at least one main channel, at least one inlet module, at least one coalescence module, and at least one detection module. The analysis unit can further include one or more sorting modules. The sorting module can be in fluid communication with branch channels which are in fluid communication with one or more outlet modules (collection module or waste module). For sorting applications, at least one detection module cooperates with at least one sorting module to divert flow via a detector-originated signal. It shall be appreciated that the “modules” and “channels” are in fluid communication with each other and therefore may overlap; i.e., there may be no clear boundary where a module or channel begins or ends. A plurality of analysis units of the invention may be combined in one device. The analysis unit and specific modules are described in further detail herein.

The dimensions of the substrate are those of typical microchips, ranging between about 0.5 cm to about 15 cm per side and about 1 micron to about 1 cm in thickness. A substrate can be transparent and can be covered with a material having transparent properties, such as a glass coverslip, to permit detection of a reporter, for example, by an optical device such as an optical microscope. The material can be perforated for functional interconnects, such as fluidic, electrical, and/or optical interconnects, and sealed to the back interface of the device so that the junction of the interconnects to the device is leak-proof. Such a device can allow for application of high pressure to fluid channels without leaking.

A variety of materials and methods, according to certain aspects of the invention, can be used to form any of the described components of the systems and devices of the invention. In some cases, the various materials selected lend themselves to various methods. For example, various components of the invention can be formed from solid materials, in which the channels can be formed via molding, micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). At least a portion of the fluidic system can be formed of silicone by molding a silicone chip. Technologies for precise and efficient formation of various fluidic systems and devices of the invention from silicone are known. Various components of the systems and devices of the invention can also be formed of a polymer, for example, an elastomeric polymer such as polydimethylsiloxane (“PDMS”), polytetrafluoroethylene (“PTFE”) or Teflon® or the like.

The channels of the invention can be formed, for example by etching a silicon chip using conventional photolithography techniques, or using a micromachining technology called “soft lithography” as described by Whitesides and Xia, Angewandte Chemie International Edition 37, 550 (1998). These and other methods may be used to provide inexpensive miniaturized devices, and in the case of soft lithography, can provide robust devices having beneficial properties such as improved flexibility, stability, and mechanical strength. When optical detection is employed, the invention also provides minimal light scatter from molecule, cell, small molecule or particle suspension and chamber material.

Different components can be formed of different materials. For example, a base portion including a bottom wall and side walls can be formed from an opaque material such as silicone or PDMS, and a top portion can be formed from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be formed as illustrated, with interior channel walls coated with another material. Material used to form various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

Various components of the invention when formed from polymeric and/or flexible and/or elastomeric materials, and can be conveniently formed of a hardenable fluid, facilitating formation via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred, for example, the silicone elastomer polydimethylsiloxane. Non-limiting examples of PDMS polymers include those sold under the trademark Sylgard by Dow Chemical Co., Midland, Mich., such as Sylgard 182, Sylgard 184, and Sylgard 186. Silicone polymers including PDMS have several beneficial properties simplifying formation of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

The present invention provides improved methods of bonding PDMS to incompatible media. Normal methods of bonding various materials (plastic, metals, etc.) directly to materials such as PDMS, silicone, Teflon, and PEEK using traditional bonding practices (adhesives, epoxies, etc.) do not work well due to the poor adhesion of the bonding agent to materials such as PDMS. Normal surface preparation by commercially available surface activators has not worked well in microfluidic device manufacturing. This problem is eliminated by treating the PDMS surface to be bonded with high intensity oxygen or air plasma. The process converts the top layer of PDMS to glass which bonds extremely well with normal adhesives. Tests using this method to bond external fluid lines to PDMS using a UV-cure adhesive (Loctite 352, 363, and others) resulted in a bond that is stronger than the PDMS substrate, resulting in fracture of the PDMS prior to failure of the bond. The present method combines high radiant flux, wavelength selection, and cure exposure time to significantly enhance the bond strength of the adhesive.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be formed and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

Another advantage to forming microfluidic structures of the invention (or interior, fluid-contacting surfaces) from oxidized silicone polymers is that these surfaces can be much more hydrophilic than the surfaces of typical elastomeric polymers (where a hydrophilic interior surface is desired). Such hydrophilic channel surfaces can thus be more easily filled and wetted with aqueous solutions than can structures comprised of typical, unoxidized elastomeric polymers or other hydrophobic materials.

In one embodiment, a bottom wall is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, thermal bonding, solvent bonding, ultrasonic welding, etc.

### Channels

The microfluidic substrates of the present invention include channels that form the boundary for a fluid. A “channel,” as used herein, means a feature on or in a substrate that at least partially directs the flow of a fluid. In some cases, the channel may be formed, at least in part, by a single component, e.g., an etched substrate or molded unit. The channel can have any cross-sectional shape, for example, circular, oval, triangular, irregular, square or rectangular (having any aspect ratio), or the like, and can be covered or uncovered (i.e., open to the external environment surrounding the channel). In embodiments where the channel is completely covered, at least one portion of the channel can have a cross-section that is completely enclosed, and/or the entire channel may be completely enclosed along its entire length with the exception of its inlet and outlet.

An open channel generally will include characteristics that facilitate control over fluid transport, e.g., structural characteristics (an elongated indentation) and/or physical or chemical characteristics (hydrophobicity vs. hydrophilicity) and/or other characteristics that can exert a force (e.g., a containing force) on a fluid. The fluid within the channel may partially or completely fill the channel. In some cases the fluid may be held or confined within the channel or a portion of the channel in some fashion, for example, using surface tension (e.g., such that the fluid is held within the channel within a meniscus, such as a concave or convex meniscus). In an article or substrate, some (or all) of the channels may be of a particular size or less, for example, having a largest dimension perpendicular to fluid flow of less than about 5 mm, less than about 2 mm, less than about 1 mm, less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm or less in some cases. Of course, in some cases, larger channels, tubes, etc. can be used to store fluids in bulk and/or deliver a fluid to the channel. In one embodiment, the channel is a capillary.

The dimensions of the channel may be chosen such that fluid is able to freely flow through the channel, for example, if the fluid contains cells. The dimensions of the channel may also be chosen, for example, to allow a certain volumetric or linear flow rate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, etc.

For particles (e.g., cells) or molecules that are in droplets (i.e., deposited by the inlet module) within the flow of the main channel, the channels of the device are preferably square, with a diameter between about 2 microns and 1 mm. This geometry facilitates an orderly flow of droplets in the channels. Similarly, the volume of the detection module in an analysis device is typically in the range of between about 0.1 picoliters and 500 nanoliters.

A “main channel” is a channel of the device of the invention which permits the flow of molecules, cells, small molecules or particles past a coalescence module for coalescing one or more droplets, a detection module for detection (identification) or measurement of a droplet and a sorting module, if present, for sorting a droplet based on the detection in the detection module. The main channel is typically in fluid communication with the coalescence, detection and/or sorting modules, as well as, an inlet channel of the inlet module. The main channel is also typically in fluid communication with an outlet module and optionally with branch channels, each of which may have a collection module or waste module. These channels permit the flow of molecules, cells, small molecules or particles out of the main channel. An “inlet channel” permits the flow of molecules, cells, small molecules or particles into the main channel. One or more inlet channels communicate with one or more means for introducing a sample into the device of the present invention. The inlet channel communicates with the main channel at an inlet module.

The microfluidic substrate can also comprise one or more fluid channels to inject or remove fluid in between droplets in a droplet stream for the purpose of changing the spacing between droplets.

The channels of the device of the present invention can be of any geometry as described. However, the channels of the device can comprise a specific geometry such that the contents of the channel are manipulated, e.g., sorted, mixed, prevent clogging, etc.

A microfluidic substrate can also include a specific geometry designed in such a manner as to prevent the aggregation of biological/chemical material and keep the biological/chemical material separated from each other prior to encapsulation in droplets. The geometry of channel dimension can be changed to disturb the aggregates and break them apart by various methods, that can include, but is not limited to, geometric pinching (to force cells through a (or a series of) narrow region(s), whose dimension is smaller or comparable to the dimension of a single cell) or a barricade (place a series of barricades on the way of the moving cells to disturb the movement and break up the aggregates of cells).

To prevent material (e.g., cells and other particles or molecules) from adhering to the sides of the channels, the channels (and coverslip, if used) may have a coating which minimizes adhesion. Such a coating may be intrinsic to the material from which the device is manufactured, or it may be applied after the structural aspects of the channels have been microfabricated. “TEFLON” is an example of a coating that has suitable surface properties. The surface of the channels of the microfluidic device can be coated with any anti-wetting or blocking agent for the dispersed phase. The channel can be coated with any protein to prevent adhesion of the biological/chemical sample. For example, in one embodiment the channels are coated with BSA, PEG-silane and/or fluorosilane. For example, 5 mg/ml BSA is sufficient to prevent attachment and prevent clogging. In another embodiment, the channels can be coated with a cyclized transparent optical polymer obtained by copolymerization of perfluoro (alkenyl vinyl ethers), such as the type sold by Asahi Glass Co. under the trademark Cytop. In such an embodiment, the coating is applied from a 0.1-0.5 wt % solution of Cytop CTL-809M in CT-Solv 180. This solution can be injected into the channels of a microfluidic device via a plastic syringe. The device can then be heated to about 90° C. for 2 hours, followed by heating at 200° C. for an additional 2 hours. In another embodiment, the channels can be coated with a hydrophobic coating of the type sold by PPG Industries, Inc. under the trademark Aquapel (e.g., perfluoroalkylalkylsilane surface treatment of plastic and coated plastic substrate surfaces in conjunction with the use of a silica primer layer) and disclosed in U.S. Pat. No. 5,523,162, which patent is hereby incorporated by reference in its entirety. By fluorinating the surfaces of the channels, the continuous phase preferentially wets the channels and allows for the stable generation and movement of droplets through the device. The low surface tension of the channel walls thereby minimizes the accumulation of channel clogging particulates.

The surface of the channels in the microfluidic device can be also fluorinated to prevent undesired wetting behaviors. For example, a microfluidic device can be placed in a polycarbonate dessicator with an open bottle of (tridecafluoro-1,1,2,2-tetrahydrooctyl)trichlorosilane. The dessicator is evacuated for 5 minutes, and then sealed for 2040 minutes. The dessicator is then backfilled with air and removed. This approach uses a simple diffusion mechanism to enable facile infiltration of channels of the microfluidic device with the fluorosilane and can be readily scaled up for simultaneous device fluorination.

### Fluids

The microfluidic device of the present invention is capable of controlling the direction and flow of fluids and entities within the device. The term “flow” means any movement of liquid or solid through a device or in a method of the invention, and encompasses without limitation any fluid stream, and any material moving with, within or against the stream, whether or not the material is carried by the stream. For example, the movement of molecules, beads, cells or virions through a device or in a method of the invention, e.g. through channels of a microfluidic chip of the invention, comprises a flow. This is so, according to the invention, whether or not the molecules, beads, cells or virions are carried by a stream of fluid also comprising a flow, or whether the molecules, cells or virions are caused to move by some other direct or indirect force or motivation, and whether or not the nature of any motivating force is known or understood. The application of any force may be used to provide a flow, including without limitation, pressure, capillary action, electro-osmosis, electrophoresis, dielectrophoresis, optical tweezers, and combinations thereof, without regard for any particular theory or mechanism of action, so long as molecules, cells or virions are directed for detection, measurement or sorting according to the invention. Specific flow forces are described in further detail herein.

The flow stream in the main channel is typically, but not necessarily, continuous and may be stopped and started, reversed or changed in speed. A liquid that does not contain sample molecules, cells or particles can be introduced into a sample inlet well or channel and directed through the inlet module, e.g., by capillary action, to hydrate and prepare the device for use. Likewise, buffer or oil can also be introduced into a main inlet region that communicates directly with the main channel to purge the device (e.g., or “dead” air) and prepare it for use. If desired, the pressure can be adjusted or equalized, for example, by adding buffer or oil to an outlet module.

As used herein, the term “fluid stream” or “fluidic stream” refers to the flow of a fluid, typically generally in a specific direction. The fluidic stream may be continuous and/or discontinuous. A “continuous” fluidic stream is a fluidic stream that is produced as a single entity, e.g., if a continuous fluidic stream is produced from a channel, the fluidic stream, after production, appears to be contiguous with the channel outlet. The continuous fluidic stream is also referred to as a continuous phase fluid or carrier fluid. The continuous fluidic stream may be laminar, or turbulent in some cases.

Similarly, a “discontinuous” fluidic stream is a fluidic stream that is not produced as a single entity. The discontinuous fluidic stream is also referred to as the dispersed phase fluid or sample fluid. A discontinuous fluidic stream may have the appearance of individual droplets, optionally surrounded by a second fluid. A “droplet,” as used herein, is an isolated portion of a first fluid that completely surrounded by a second fluid. In some cases, the droplets may be spherical or substantially spherical; however, in other cases, the droplets may be non-spherical, for example, the droplets may have the appearance of “blobs” or other irregular shapes, for instance, depending on the external environment. As used herein, a first entity is “surrounded” by a second entity if a closed loop can be drawn or idealized around the first entity through only the second entity. The dispersed phase fluid can include a biological/chemical material. The biological/chemical material can be tissues, cells, particles, proteins, antibodies, amino acids, nucleotides, small molecules, and pharmaceuticals. The biological/chemical material can include one or more labels known in the art. The label can be a DNA tag, dyes or quantum dot, or combinations thereof.

### Droplets

The term “emulsion” refers to a preparation of one liquid distributed in small globules (also referred to herein as drops, droplets or NanoReactors) in the body of a second liquid. The first and second fluids are immiscible with each other. For example, the discontinuous phase can be an aqueous solution and the continuous phase can be a hydrophobic fluid such as an oil. This is termed a water-in-oil emulsion. Alternatively, the emulsion may be an oil-in-water emulsion. In that example, the first liquid, which is dispersed in globules, is referred to as the discontinuous phase, whereas the second liquid is referred to as the continuous phase or the dispersion medium. The continuous phase can be an aqueous solution and the discontinuous phase is a hydrophobic fluid, such as an oil (e.g., decane, tetradecane, or hexadecane). The droplets or globules of oil in an oil-in-water emulsion are also referred to herein as “micelles”, whereas globules of water in a water-in-oil emulsion may be referred to as “reverse micelles”.

The fluidic droplets may each be substantially the same shape and/or size. The shape and/or size can be determined, for example, by measuring the average diameter or other characteristic dimension of the droplets. The “average diameter” of a plurality or series of droplets is the arithmetic average of the average diameters of each of the droplets. Those of ordinary skill in the art will be able to determine the average diameter (or other characteristic dimension) of a plurality or series of droplets, for example, using laser light scattering, microscopic examination, or other known techniques. The diameter of a droplet, in a non-spherical droplet, is the mathematically-defined average diameter of the droplet, integrated across the entire surface. The average diameter of a droplet (and/or of a plurality or series of droplets) may be, for example, less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers in some cases. The average diameter may also be at least about 1 micrometer, at least about 2 micrometers, at least about 3 micrometers, at least about 5 micrometers, at least about 10 micrometers, at least about 15 micrometers, or at least about 20 micrometers in certain cases.

As used herein, the term “NanoReactor” and its plural encompass the terms “droplet”, “nanodrop”, “nanodroplet”, “microdrop” or “microdroplet” as defined herein, as well as an integrated system for the manipulation and probing of droplets, as described in detail herein. Nanoreactors as described herein can be 0.1-1000 μm (e.g., 0.1, 0.2 . . . 5, 10, 15, 20, 25, 30, 35, 40, 45, 50 . . . 1000 μm), or any size within in this range. Droplets at these dimensions tend to conform to the size and shape of the channels, while maintaining their respective volumes. Thus, as droplets move from a wider channel to a narrower channel they become longer and thinner, and vice versa.

The microfluidic substrate of this invention most preferably generates round, monodisperse droplets. The droplets can have a diameter that is smaller than the diameter of the microchannel; i.e., preferably 15 to 100 μm when cells are used; or 10 to 75 μm when reagents or other chemical or biological agents are used; or 100 to 1000 μm when droplets are used for sequencing reactions such that droplets will be removed and dispensed into other collection apparatuses, such as microtiter plates or utilized in sequencing devices. Monodisperse droplets are particularly preferably, e.g., in high throughput devices and other embodiments where it is desirable to generate droplets at high frequency and of high uniformity.

The droplet forming liquid is typically an aqueous buffer solution, such as ultrapure water (e.g., 18 mega-ohm resistivity, obtained, for example by column chromatography), 10 mM Tris HCl and 1 mM EDTA (TE) buffer, phosphate buffer saline (PBS) or acetate buffer. Any liquid or buffer that is physiologically compatible with the population of molecules, cells or particles to be analyzed and/or sorted can be used. The fluid passing through the main channel and in which the droplets are formed is one that is immiscible with the droplet forming fluid. The fluid passing through the main channel can be a non-polar solvent, decane (e.g., tetradecane or hexadecane), fluorocarbon oil, silicone oil or another oil (for example, mineral oil).

The dispersed phase fluid may also contain biological/chemical material (e.g., molecules, cells, or other particles) for combination, analysis and/or sorting in the device. The droplets of the dispersed phase fluid can contain more than one particle or can contain no more than one particle. For example, where the biological material comprises cells, each droplet preferably contains, on average, no more than one cell. However, in some embodiments, each droplet may contain, on average, at least 1000 cells. The droplets can be detected and/or sorted according to their contents.

The concentration (i.e., number) of molecules, cells or particles in a droplet can influence sorting efficiently and therefore is preferably optimized. In particular, the sample concentration should be dilute enough that most of the droplets contain no more than a single molecule, cell or particle, with only a small statistical chance that a droplet will contain two or more molecules, cells or particles. This is to ensure that for the large majority of measurements, the level of reporter measured in each droplet as it passes through the detection module corresponds to a single molecule, cell or particle and not to two or more molecules, cells or particles.

The parameters which govern this relationship are the volume of the droplets and the concentration of molecules, cells or particles in the sample solution. The probability that a droplet will contain two or more molecules, cells or particles (P≦₂) can be expressed as

P≦₂=1−{1+[cell]×v}×e^{-[cell]×V}

where “[cell]” is the concentration of molecules, cells or particles in units of number of molecules, cells or particles per cubic micron (μm³), and V is the volume of the droplet in units of μm³.

It will be appreciated that P≦₂ can be minimized by decreasing the concentration of molecules, cells or particles in the sample solution. However, decreasing the concentration of molecules, cells or particles in the sample solution also results in an increased volume of solution processed through the device and can result in longer run times. Accordingly, it is desirable to minimize to presence of multiple molecules, cells or particles in the droplets (thereby increasing the accuracy of the sorting) and to reduce the volume of sample, thereby permitting a sorted sample in a reasonable time in a reasonable volume containing an acceptable concentration of molecules, cells or particles.

The maximum tolerable P≦₂ depends on the desired “purity” of the sorted sample. The “purity” in this case refers to the fraction of sorted molecules, cells or particles that possess a desired characteristic (e.g., display a particular antigen, are in a specified size range or are a particular type of molecule, cell or particle). The purity of the sorted sample is inversely proportional to P≦₂. For example, in applications where high purity is not needed or desired a relatively high P≦₂ (e.g., P≦₂=0.2) may be acceptable. For most applications, maintaining P≦₂ at or below about 0.1, preferably at or below about 0.01, provides satisfactory results.

The fluids used to generate droplets in microfluidic devices are typically immiscible liquids such as oil and water. These two materials generally have very different dielectric constants associated with them. These differences can be exploited to determine droplet rate and size for every drop passing through a small section of a microfluidic device. One method to directly monitor this variation in the dielectric constant measures the change in capacitance over time between a pair of closely spaced electrodes. This change in capacitance can be detected by the change in current measured in these electrodes:

i=V×dC/dt

Where i is the current, V is the voltage applied across the electrodes, and dC/dt is the change in capacitance with time. Alternatively, the capacitance can be measured directly if a time varying voltage is applied to these same electrodes: i=C×dV/dt Where C is the measured capacitance, and dV/dt is the change in voltage with time. As a first approximation, the electrode pair can be determined as a parallel plate capacitor:

C=∈₀k×A/d

Where ∈₀ is the permittivity of free space, k is the effective dielectric constant (this changes every time a droplet passes through), A is the area of the capacitor and d is the electrode separation. The current measured in the device is then plotted as a function of time.

The fluidic droplets may contain additional entities, for example, other chemical, biochemical, or biological entities (e.g., dissolved or suspended in the fluid), cells, particles, gases, molecules, or the like. In some cases, the droplets may each be substantially the same shape or size, as discussed above. In certain instances, the invention provides for the production of droplets consisting essentially of a substantially uniform number of entities of a species therein (i.e., molecules, cells, particles, etc.). For example, about 90%, about 93%, about 95%, about 97%, about 98%, or about 99%, or more of a plurality or series of droplets may each contain the same number of entities of a particular species. For instance, a substantial number of fluidic droplets produced, e.g., as described above, may each contain 1 entity, 2 entities, 3 entities, 4 entities, 5 entities, 7 entities, 10 entities, 15 entities, 20 entities, 25 entities, 30 entities, 40 entities, 50 entities, 60 entities, 70 entities, 80 entities, 90 entities, 100 entities, etc., where the entities are molecules or macromolecules, cells, particles, etc. In some cases, the droplets may each independently contain a range of entities, for example, less than 20 entities, less than 15 entities, less than 10 entities, less than 7 entities, less than 5 entities, or less than 3 entities in some cases. In some embodiments, a droplet may contain 100,000,000 entities. In other embodiments, a droplet may contain 1,000,000 entities.

In a liquid containing droplets of fluid, some of which contain a species of interest and some of which do not contain the species of interest, the droplets of fluid may be screened or sorted for those droplets of fluid containing the species as further described below (e.g., using fluorescence or other techniques such as those described above), and in some cases, the droplets may be screened or sorted for those droplets of fluid containing a particular number or range of entities of the species of interest, e.g., as previously described. Thus, in some cases, a plurality or series of fluidic droplets, some of which contain the species and some of which do not, may be enriched (or depleted) in the ratio of droplets that do contain the species, for example, by a factor of at least about 2, at least about 3, at least about 5, at least about 10, at least about 15, at least about 20, at least about 50, at least about 100, at least about 125, at least about 150, at least about 200, at least about 250, at least about 500, at least about 750, at least about 1000, at least about 2000, or at least about 5000 or more in some cases. In other cases, the enrichment (or depletion) may be in a ratio of at least about 10⁴, at least about 10⁵, at least about 10⁶, at least about 10⁷, at least about 10⁸, at least about 10⁹, at least about 10¹⁰, at least about 10¹¹, at least about 10¹², at least about 10¹³, at least about 10¹⁴, at least about 10¹⁵, or more. For example, a fluidic droplet containing a particular species may be selected from a library of fluidic droplets containing various species, where the library may have about 100, about 10³, about 10⁴, about 10⁵, about 10⁶, about 10⁷, about 10⁸, about 10⁹, about 10¹⁰, about 10¹¹, about 10¹², about 10¹³, about 10¹⁴, about 10¹⁵, or more items, for example, a DNA library, an RNA library, a protein library, a combinatorial chemistry library, etc. In certain embodiments, the droplets carrying the species may then be fused, reacted, or otherwise used or processed, etc., as further described below, for example, to initiate or determine a reaction.

Droplets of a sample fluid can be formed within the inlet module on the microfluidic device or droplets (or droplet libraries) can be formed before the sample fluid is introduced to the microfluidic device (“off chip” droplet formation). To permit effective interdigitation, coalescence and detection, the droplets comprising each sample to be analyzed must be monodisperse. As described in more detail herein, in many applications, different samples to be analyzed are contained within droplets of different sizes. Droplet size must be highly controlled to ensure that droplets containing the correct contents for analysis and coalesced properly. As such, the present invention provides devices and methods for forming droplets and droplet libraries.

### Surfactants

The fluids used in the invention may contain one or more additives, such as agents which reduce surface tensions (surfactants). Surfactants can include Tween, Span, fluorosurfactants, and other agents that are soluble in oil relative to water. In some applications, performance is improved by adding a second surfactant to the aqueous phase. Surfactants can aid in controlling or optimizing droplet size, flow and uniformity, for example by reducing the shear force needed to extrude or inject droplets into an intersecting channel. This can affect droplet volume and periodicity, or the rate or frequency at which droplets break off into an intersecting channel. Furthermore, the surfactant can serve to stabilize aqueous emulsions in fluorinated oils from coalescing.

The droplets may be coated with a surfactant. Preferred surfactants that may be added to the continuous phase fluid include, but are not limited to, surfactants such as sorbitan-based carboxylic acid esters (e.g., the “Span” surfactants, Fluka Chemika), including sorbitan monolaurate (Span 20), sorbitan monopalmitate (Span 40), sorbitan monostearate (Span 60) and sorbitan monooleate (Span 80), and perfluorinated polyethers (e.g., DuPont Krytox 157 FSL, FSM, and/or FSH). Other non-limiting examples of non-ionic surfactants which may be used include polyoxyethylenated alkylphenols (for example, nonyl-, p-dodecyl-, and dinonylphenols), polyoxyethylenated straight chain alcohols, polyoxyethylenated polyoxypropylene glycols, polyoxyethylenated mercaptans, long chain carboxylic acid esters (for example, glyceryl and polyglycerl esters of natural fatty acids, propylene glycol, sorbitol, polyoxyethylenated sorbitol esters, polyoxyethylene glycol esters, etc.) and alkanolamines (e.g., diethanolamine-fatty acid condensates and isopropanolamine-fatty acid condensates). In addition, ionic surfactants such as sodium dodecyl sulfate (SDS) may also be used. However, such surfactants are generally less preferably for many embodiments of the invention. For instance, in those embodiments where aqueous droplets are used as nanoreactors for chemical reactions (including biochemical reactions) or are used to analyze and/or sort biomaterials, a water soluble surfactant such as SDS may denature or inactivate the contents of the droplet.

The carrier fluid can be an oil (e.g., decane, tetradecane or hexadecane) or fluorocarbon oil that contains a surfactant (e.g., a non-ionic surfactant such as a Span surfactant) as an additive (preferably between about 0.2 and 5% by volume, more preferably about 2%). A user can preferably cause the carrier fluid to flow through channels of the microfluidic device so that the surfactant in the carrier fluid coats the channel walls.

In one embodiment, the fluorosurfactant can be prepared by reacting the perflourinated polyether DuPont Krytox 157 FSL, FSM, or FSH with aqueous ammonium hydroxide in a volatile fluorinated solvent. The solvent and residual water and ammonia can be removed with a rotary evaporator. The surfactant can then be dissolved (e.g., 2.5 wt %) in a fluorinated oil (e.g., Flourinert (3M)), which then serves as the continuous phase of the emulsion.

### Driving Forces

The invention can use pressure drive flow control, e.g., utilizing valves and pumps, to manipulate the flow of cells, particles, molecules, enzymes or reagents in one or more directions and/or into one or more channels of a microfluidic device. However, other methods may also be used, alone or in combination with pumps and valves, such as electro-osmotic flow control, electrophoresis and dielectrophoresis (Fulwyer, Science 156, 910 (1974); Li and Harrison, Analytical Chemistry 69, 1564 (1997); Fiedler, et al. Analytical Chemistry 70, 1909-1915 (1998); U.S. Pat. No. 5,656,155). Application of these techniques according to the invention provides more rapid and accurate devices and methods for analysis or sorting, for example, because the sorting occurs at or in a sorting module that can be placed at or immediately after a detection module. This provides a shorter distance for molecules or cells to travel, they can move more rapidly and with less turbulence, and can more readily be moved, examined, and sorted in single file, i.e., one at a time.

Positive displacement pressure driven flow is a preferred way of controlling fluid flow and dielectrophoresis is a preferred way of manipulating droplets within that flow.

The pressure at the inlet module can also be regulated by adjusting the pressure on the main and sample inlet channels, for example, with pressurized syringes feeding into those inlet channels. By controlling the pressure difference between the oil and water sources at the inlet module, the size and periodicity of the droplets generated may be regulated. Alternatively, a valve may be placed at or coincident to either the inlet module or the sample inlet channel connected thereto to control the flow of solution into the inlet module, thereby controlling the size and periodicity of the droplets. Periodicity and droplet volume may also depend on channel diameter, the viscosity of the fluids, and shear pressure.

Without being bound by any theory, electro-osmosis is believed to produce motion in a stream containing ions e.g. a liquid such as a buffer, by application of a voltage differential or charge gradient between two or more electrodes. Neutral (uncharged) molecules or cells can be carried by the stream. Electro-osmosis is particularly suitable for rapidly changing the course, direction or speed of flow. Electrophoresis is believed to produce movement of charged objects in a fluid toward one or more electrodes of opposite charge, and away from one on or more electrodes of like charge. Where an aqueous phase is combined with an oil phase, aqueous droplets are encapsulated or separated from each other by oil. Typically, the oil phase is not an electrical conductor and may insulate the droplets from the electro-osmotic field. In this example, electro-osmosis may be used to drive the flow of droplets if the oil is modified to carry or react to an electrical field, or if the oil is substituted for another phase that is immiscible in water but which does not insulate the water phase from electrical fields.

Dielectrophoresis is believed to produce movement of dielectric objects, which have no net charge, but have regions that are positively or negatively charged in relation to each other. Alternating, non-homogeneous electric fields in the presence of droplets and/or particles, such as cells or molecules, cause the droplets and/or particles to become electrically polarized and thus to experience dielectrophoretic forces. Depending on the dielectric polarizability of the particles and the suspending medium, dielectric particles will move either toward the regions of high field strength or low field strength. For example, the polarizability of living cells depends on their composition, morphology, and phenotype and is highly dependent on the frequency of the applied electrical field. Thus, cells of different types and in different physiological states generally possess distinctly different dielectric properties, which may provide a basis for cell separation, e.g., by differential dielectrophoretic forces. Likewise, the polarizability of droplets also depends upon their size, shape and composition. For example, droplets that contain salts can be polarized. According to formulas provided in Fiedler, et al. Analytical Chemistry 70, 1909-1915 (1998), individual manipulation of single droplets requires field differences (inhomogeneities) with dimensions close to the droplets.

The term “dielectrophoretic force gradient” means a dielectrophoretic force is exerted on an object in an electric field provided that the object has a different dielectric constant than the surrounding media. This force can either pull the object into the region of larger field or push it out of the region of larger field. The force is attractive or repulsive depending respectively on whether the object or the surrounding media has the larger dielectric constant.

Manipulation is also dependent on permittivity (a dielectric property) of the droplets and/or particles with the suspending medium. Thus, polymer particles, living cells show negative dielectrophoresis at high-field frequencies in water. For example, dielectrophoretic forces experienced by a latex sphere in a 0.5 MV/m field (10 V for a 20 micron electrode gap) in water are predicted to be about 0.2 piconewtons (pN) for a 3.4 micron latex sphere to 15 pN for a 15 micron latex sphere (Fiedler, et al. Analytical Chemistry 70, 1909-1915 (1998)). These values are mostly greater than the hydrodynamic forces experienced by the sphere in a stream (about 0.3 pN for a 3.4 micron sphere and 1.5 pN for a 15 micron sphere). Therefore, manipulation of individual cells or particles can be accomplished in a streaming fluid, such as in a cell sorter device, using dielectrophoresis. Using conventional semiconductor technologies, electrodes can be microfabricated onto a substrate to control the force fields in a microfabricated sorting device of the invention. Dielectrophoresis is particularly suitable for moving objects that are electrical conductors. The use of AC current is preferred, to prevent permanent alignment of ions. Megahertz frequencies are suitable to provide a net alignment, attractive force, and motion over relatively long distances. See U.S. Pat. No. 5,454,472.

Radiation pressure can also be used in the invention to deflect and move objects, e.g. droplets and particles (molecules, cells, particles, etc.) contained therein, with focused beams of light such as lasers. Flow can also be obtained and controlled by providing a pressure differential or gradient between one or more channels of a device or in a method of the invention.

Molecules, cells or particles (or droplets containing molecules, cells or particles) can be moved by direct mechanical switching, e.g., with on-off valves or by squeezing the channels. Pressure control may also be used, for example, by raising or lowering an output well to change the pressure inside the channels on the chip. See, e.g., the devices and methods described U.S. Pat. No. 6,540,895. These methods and devices can further be used in combination with the methods and devices described in pending U.S. Patent Application Publication No. 20010029983 and 20050226742. Different switching and flow control mechanisms can be combined on one chip or in one device and can work independently or together as desired.

### Inlet Module

The microfluidic device of the present invention includes one or more inlet modules. An “inlet module” is an area of a microfluidic substrate device that receives molecules, cells, small molecules or particles for additional coalescence, detection and/or sorting. The inlet module can contain one or more inlet channels, wells or reservoirs, openings, and other features which facilitate the entry of molecules, cells, small molecules or particles into the substrate. A substrate may contain more than one inlet module if desired. Different sample inlet channels can communicate with the main channel at different inlet modules. Alternately, different sample inlet channels can communication with the main channel at the same inlet module. The inlet module is in fluid communication with the main channel. The inlet module generally comprises a junction between the sample inlet channel and the main channel such that a solution of a sample (i.e., a fluid containing a sample such as molecules, cells, small molecules (organic or inorganic) or particles) is introduced to the main channel and forms a plurality of droplets. The sample solution can be pressurized. The sample inlet channel can intersect the main channel such that the sample solution is introduced into the main channel at an angle perpendicular to a stream of fluid passing through the main channel. For example, the sample inlet channel and main channel intercept at a T-shaped junction; i.e., such that the sample inlet channel is perpendicular (90 degrees) to the main channel. However, the sample inlet channel can intercept the main channel at any angle, and need not introduce the sample fluid to the main channel at an angle that is perpendicular to that flow. The angle between intersecting channels is in the range of from about 60 to about 120 degrees. Particular exemplary angles are 45, 60, 90, and 120 degrees.

Embodiments of the invention are also provided in which there are two or more inlet modules introducing droplets of samples into the main channel. For example, a first inlet module may introduce droplets of a first sample into a flow of fluid in the main channel and a second inlet module may introduce droplets of a second sample into the flow of fluid in main channel, and so forth. The second inlet module is preferably downstream from the first inlet module (e.g., about 30 μm). The fluids introduced into the two or more different inlet modules can comprise the same fluid or the same type of fluid (e.g., different aqueous solutions). For example, droplets of an aqueous solution containing an enzyme are introduced into the main channel at the first inlet module and droplets of aqueous solution containing a substrate for the enzyme are introduced into the main channel at the second inlet module. Alternatively, the droplets introduced at the different inlet modules may be droplets of different fluids which may be compatible or incompatible. For example, the different droplets may be different aqueous solutions, or droplets introduced at a first inlet module may be droplets of one fluid (e.g., an aqueous solution) whereas droplets introduced at a second inlet module may be another fluid (e.g., alcohol or oil).

### Reservoir/Well

A device of the invention can include a sample solution reservoir or well or other apparatus for introducing a sample to the device, at the inlet module, which is typically in fluid communication with an inlet channel. Reservoirs and wells used for loading one or more samples onto the microfluidic device of the present invention, include but are not limited to, syringes, pipettes, cartridges, vials, eppendorf tubes and cell culture materials (e.g., 96 well plates). A reservoir may facilitate introduction of molecules or cells into the device and into the sample inlet channel of each analysis unit.

### Fluidic Interconnects

The microfluidic device can include a pipette, a syringe (or other glass container), or a tubing that is treated with a vapor or solution of an appropriate PEG-silane to effect the surface PEG functionalization. The purpose for treating the walls of glass containers (e.g., syringes) with a PEG functionality is to prevent biological adhesion to the inner walls of the container, which frustrates the proper transfer of biological/chemical materials into the microfluidic device of the present invention. The inlet channel is further connected to a means for introducing a sample to said device. The means can be a well or reservoir. The means can be temperature controlled. The inlet module may also contain a connector adapted to receive a suitable piece of tubing, such as liquid chromatography or HPLC tubing, through which a sample may be supplied. Such an arrangement facilitates introducing the sample solution under positive pressure in order to achieve a desired infusion rate at the inlet module.

The interconnections, including tubes, must be extremely clean and make excellent bonding with the PDMS surface in order to allow proper operation of the device. The difficulty in making a fluidic connection to a microfluidic device is primarily due to the difficulty in transitioning from a macroscopic fluid line into the device while minimizing dead volume.

In order to minimize contamination and leakage and allow for greater reproducibility and reliability are improved, tubes and interconnects for the PDMS slab can be cured in place. The tubes and interconnects can be placed in position by applying a UV-cured adhesive to allow for holding the tubes in place on the silicone wafer. Once the tubes are placed in position, PDMS can be poured over the wafer and cured. The cured PDMS, along with the tubes in place, can be peeled off of the silicone wafer easily. This process can be applied to fluidics channels as well as other connection channels. Once the adhesive is applied onto the wafer, the process will allow for quick templating of PDMS slabs with exact reproducibility of channel locations and cleanliness. Tubes of any size can be implemented for this process. This process allows for less stress on the interconnection joints and smaller interconnection footprints in the device (see, for example, PCT/US2006/02186 filed on Jun. 1, 2006; PCT/US2006/021280 filed on Jun. 1, 2006 and PCT/US2006/021380 filed on Jun. 1, 2006, each of which is incorporated by reference in their entirety for all purposes).

The tubing side of the interconnect can be mounted into a retaining block that provides precise registration of the tubing, while the microfluidic device can be positioned accurately in a carrier that the retaining block would align and clamp to. The total dead volume associated with these designs would be critically dependent on how accurately the two mating surfaces could be positioned relative to each other. The maximum force required to maintain the seal would be limited by the exact shape and composition of the sealing materials as well as the rigidity and strength of the device itself. The shapes of the mating surfaces can be tailored to the minimal leakage potential, sealing force required, and potential for misalignment. By way of non-limiting example, the single ring indicated in can be replaced with a series of rings of appropriate cross-sectional shape.

Reservoirs and wells used for loading one or more samples onto the microfluidic device of the present invention include but are not limited to pipettes, syringes, cartridges, vials, eppendorf tubes and cell culture materials (e.g., 96 well plates) as described above. One of the issues to be resolved in loading samples into the inlet channel at the inlet module of the substrate is the size difference between the loading means or injection means, e.g., capillary or HPLC tubing and the inlet channel. It is necessary to create an interconnect and loading method which limits leaks and minimizes dead volume and compliance problems. Several devices and methods described in further detail herein address and solve these art problems.

### Self-Aligning Fluidic Interconnects

The present invention includes one or more inlet modules comprising self-aligning fluidic interconnects proximate to one or more inlet channels to improve the efficiency of sample loading and/or injection.

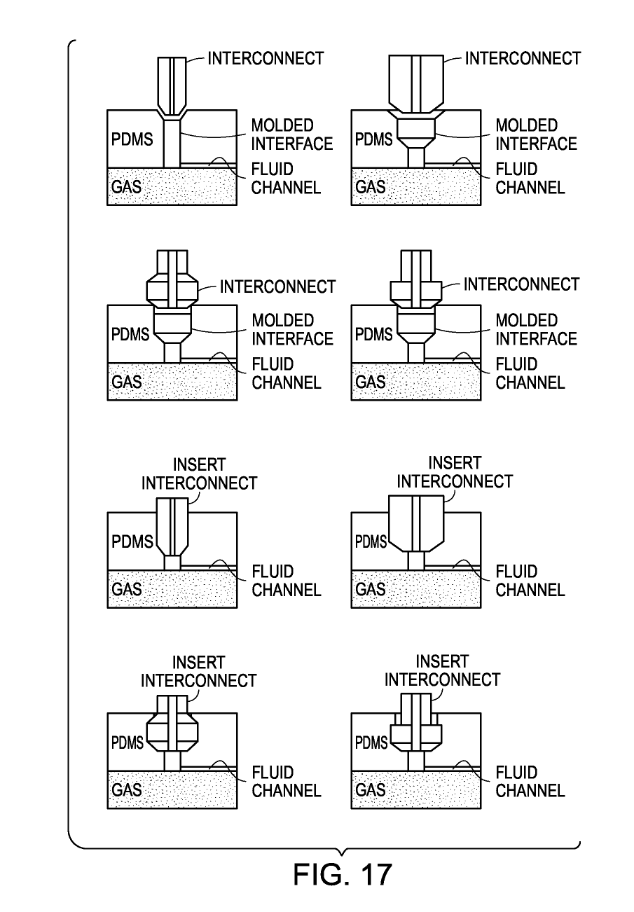

The present invention proposes the use of small interconnects based on creating a radial seal instead of a face seal between the microfluidic device and interconnect. The inserted interconnect would have a larger diameter than the mating feature on the device. When inserted, the stretching of the chip would provide the sealing force needed to make a leak-free seal between the external fluid lines and the microfluidic device. FIG. 17 details design possibilities for making this seal.

Studies were performed using a cast hole in PDMS and 1/32″ PEEK tubing, which showed that the seal was able to withstand more than 90 PSI of pressure without leakage.

In order to handle instrument and chip manufacturing tolerances, the external interconnect must be self-aligning and the “capture radius” of the molded hole must be large enough to reliably steer the interconnect to the sealing surfaces. FIG. 18 shows that the entrance to the molded hole is large enough to guarantee capture but tapers down to the sealing surfaces. The external interconnect could be made directly out of the tubing leading up to the microfluidic substrate, thus eliminating potential leak points and unswept volumes. As seen in FIG. 18, the interconnect is surrounded by the substrate interconnects or “chip dock” for most of its length to make certain it is held within the tolerance stack-up of the system. The external interconnect is made from a hard but flexible material such as 1/32″ PEEK tubing. The features in the microfluidic device can be molded directly into it during the manufacturing process, while the inserted seals can be molded/machined directly onto the tubing ends or molded as individual pieces and mechanically fastened to the tubing. The retaining ferrule shown in FIG. 18 would be attached during manufacturing and provide good absolute referencing of the tube length. The ferrule could be an off-the-shelf component or a custom manufactured part and be made from, for example, a polymer, an elastomer, or a metal. The tubing end could be tapered on the end (top most diagram) or squared off (the figure above). The specific shape of the end will be controlled by how easily the microfluidic device will gall during insertion.

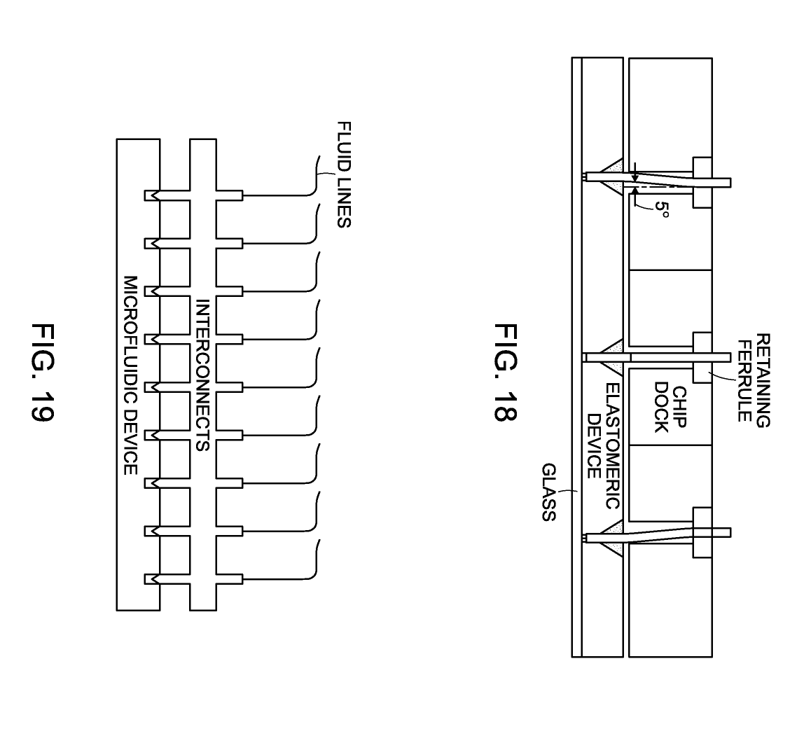

Alternatively, it is also possible to mold all the interconnects needed for each tube into a single monolithic self-aligned part as detailed in FIG. 19. This may help reduce the difficulty in maintaining alignment of many external fluidic lines to the chip.

### Elastomeric Fluid Interconnects

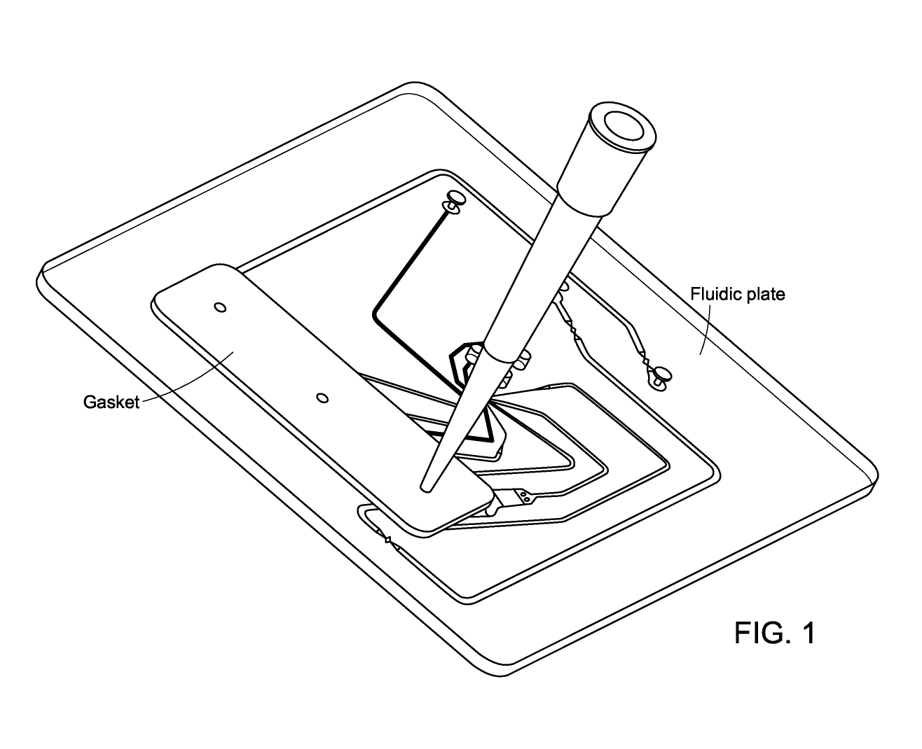

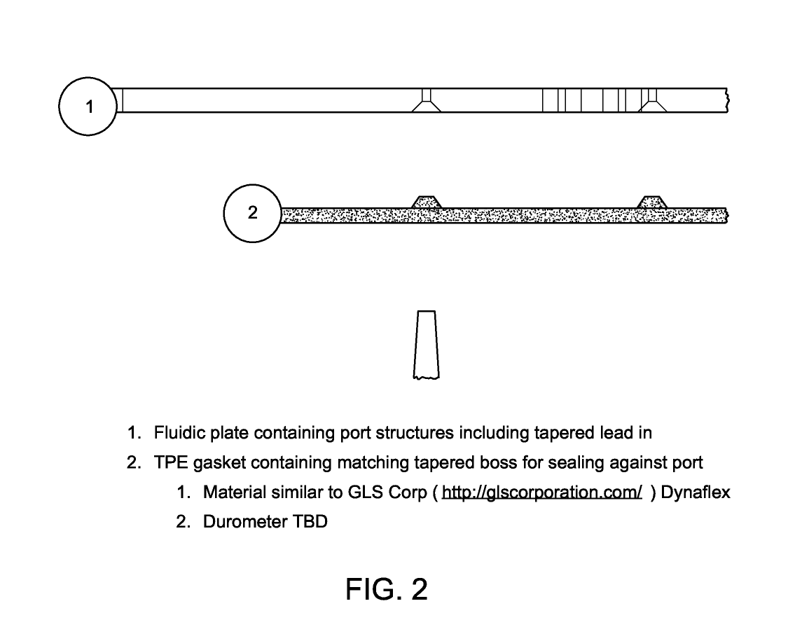

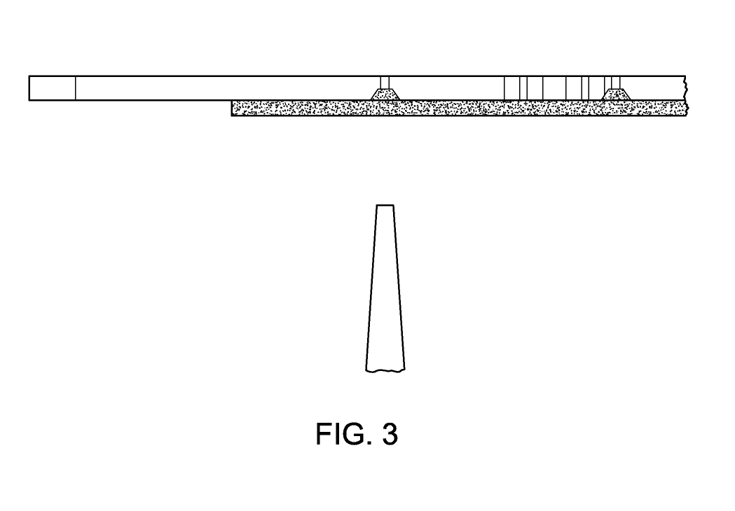

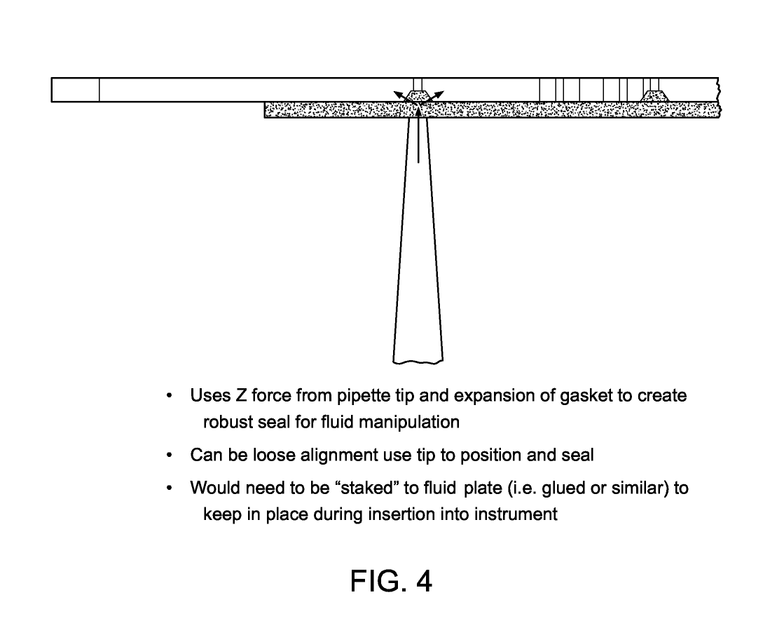

A conceptual layout of a microfluidic chip having an elastomeric radial seal (also referred to herein as a “gasket”) interface between the fluidic plate and a means for introducing a sample (e.g., a pipette or tubing) is shown in FIG. 1. A cross section of the microfluidic chip depicted in FIG. 1 is shown in FIG. 2. As shown in FIG. 2, the fluidic plate contains one or more port structures that include a tapered lead directly into a microfluidic channel. The elastomeric gasket includes one or more tapered bosses that are configured to fit within the one or more port structures in the microfluidic chip. The gasket and fluidic plate depicted in FIG. 2 are shown assembled in FIG. 3. As shown in FIG. 4, the downward force of the sample introduction means (also referred to herein as a “fluid transport mechanism”, e.g., a pipette or tubing) radially compresses (Z force) the gasket, thereby creating a seal between the gasket and the port structure in the microfluidic chip. The gasket can be loosely aligned with the one or more port structures prior to sealing by the radial compression applied by the sample introduction means. Optionally, the gasket/chip assembly can be staked (e.g., heat bonded, glued or clamped) to a carrier apparatus prior to sealing to facilitate insertion of the assembly into an instrument for analysis. Staking of the gasket/chip assembly to a carrier causes axial compression against the gasket to further induce sealing between the gasket and port assembly. However, axial compression is not required. The radial compression by the sample introduction means is sufficient to seal the gasket.

The conceptual design depicted in FIGS. 1-4 minimizes the requirements on precision of the fluid interface, and can accommodate many options for materials of different durometer. Although the conceptual design depicted in FIGS. 1-4 requires an additional mold to produce the gasket, and post-mold assembly with the fluid plate, assembly/alignment of the loose parts is not expected to add any significant complexity to the assembly. Furthermore, the design keeps a planar part for ease of bonding and creates all disposable wetted parts to eliminate any cross contamination.

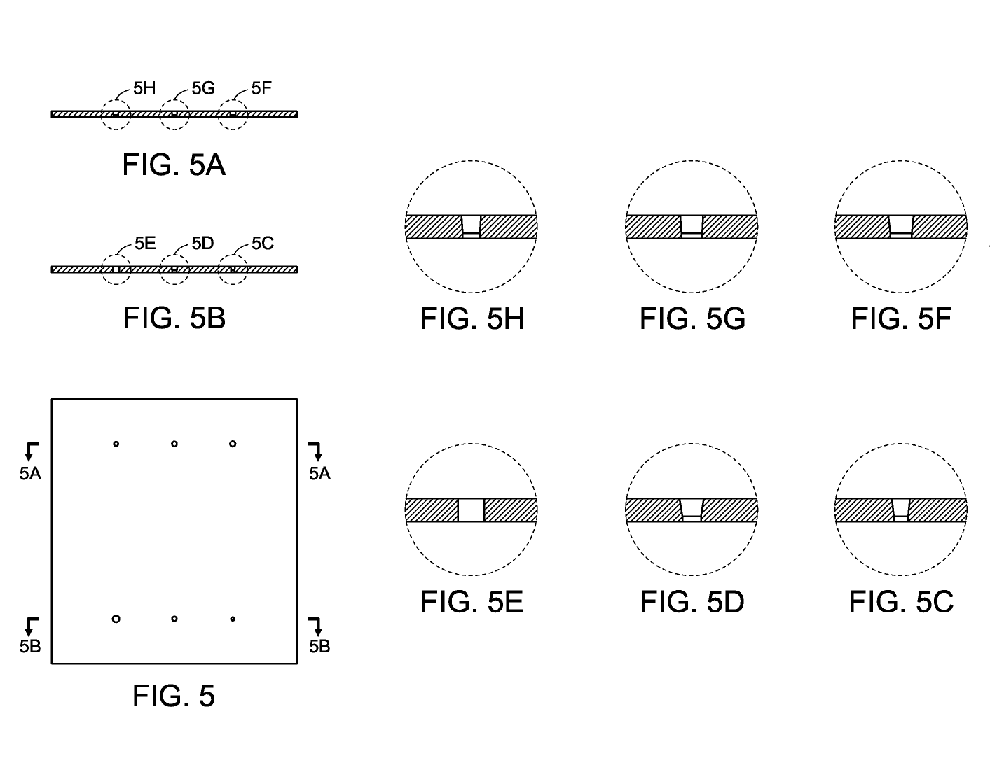

Shifting focus now to the port modules or ports within the microfluidic chip, the port modules can be configured to accommodate a variety of different shapes and sizes of different types of sample introduction means. For example, the port module within the gasket can be designed to accommodate tubing (e.g., PEEK tubing), a 10 μL pipette, a 25 μL pipette, a 50 μL pipette, a 100 μL pipette, a 500 μL pipette, a 1000 μL pipette, etc. Six exemplary embodiments of different configurations for the port modules within the fluidic plate are depicted in FIG. 5 (depicted as Detail C through Detail H). As shown in FIG. 5, the dimensions and angle of the port module can vary. For example, the port module can be substantially perpendicular to the microfluidic channel, as depicted in Detail E in FIG. 5. Alternatively, the port module can include a tapered angle of varying degrees, as depicted in Detail C, D, F, G, and H.

It should be noted that a portion of the gasket is configured to fit at least partially into a port, while another portion of the gasket is configured to sealingly receive the pipette or other means for introducing a sample fluid (e.g., tubing). In particular, a bottom portion of the tapered bosses formed within the gasket are configured to align and fit at least partially within the port modules in the fluid plate. A top portion of the same bosses receive the means for introducing a sample fluid (e.g., a tube or pipette). As such, the bosses within the gasket should be of similar dimensions and angles as the port modules with which they are aligned.

In certain embodiments, the microfluidic chip/gasket assembly is housed within a plastic carrier. A plastic housing can be useful for stacking the microfluidic chips within an instrument, particularly a robotic instrument. The plastic carrier can include information such as a bar code to identify particular sample fluids and/or experiments being conducted within the microfluidic chip. Alternatively, a bar code can be printed directly on the microfluidic chip.

Where a plastic carrier is used, the chip/gasket assembly can be held within the plastic carrier by a clamp, or can be heat-staked or glued to the plastic carrier. Clamping, heat-staking or gluing the chip/gasket assembly to the plastic carrier provides axial compression against the gasket to help induce a fluid-tight seal at the fluid interface, in addition to the radial compression provided against the gasket by insertion of a sample introduction means into a port module. However, it should be noted that axial compression against the gasket is not necessary to induce a fluid-tight seal at the fluid interface. A sufficiently strong seal (e.g., able to hold pressure up to 100 psi) can be created by radial compression only against the gasket.

The microfluidic chip/gasket/plastic carrier can be assembled in a variety of configurations. Exemplary embodiments of the different configurations are described in Table 1 below.

TABLE 1
Examples of Chip/Gasket/Carrier Configurations

| | Chip/Carrier | Overall | |
|---|---|---|---|
| Configuration | Configuration | Thickness | Notes |
| 1 | 2 piece carrier, | 7 mm | Clamp used to fix |
| | injection molded | | chip to carrier |
| | type gasket | | |
| | 1 piece carrier, | 6 mm | heat staking or |
| | injection molded | | gluing used to fix |
| | type gasket | | chip to carrier |
| 2 | 2 piece carrier, | 7 mm | Clamp used to fix |
| | Overmolded gasket | | chip to carrier |
| | 1 piece carrier, | 6 mm | heat staking or |
| | Overmolded gasket | | gluing used to fix |
| | | | chip to carrier |
| 3 | Chip is Carrier, | 4.4 mm | |
| | Gasket in Chip | | |
| 4 | 2 piece carrier, | 5 mm | Clamp used to fix |
| | Gasket in Chip | | chip to carrier |
| | 1 piece carrier, | 4 mm | Counts on heat |
| | Gasket in Chip | | staking or gluing |

In Configuration 1, the microfluidic chip and gaskets are injection molded separately and assembled within a 2 piece or 1 piece plastic carrier, depending on whether a clamp is used to fix the chip/gasket assembly within the plastic carrier (i.e., a 2 piece carrier). The microfluidic chip includes a top plate and a bottom plate that are bonded together. The top and bottom plates are of uniform thickness (e.g., 1.7 mm). The bottom plate has microfluidic channels molded or etched into the plate. The top plate includes port modules that lead directly into the microfluidic channels when the top plate is fitted over the bottom plate. The gasket is fitted over the top plate, the bosses being aligned with the port modules in the top plate. The chip/gasket assembly is inserted into a plastic carrier. A clamp can be used to fix the chip to the carrier (2 piece carrier) and provides axial compression against the gasket interface. Alternatively the chip can be heat-staked or glued to the plastic carrier (1 piece carrier).

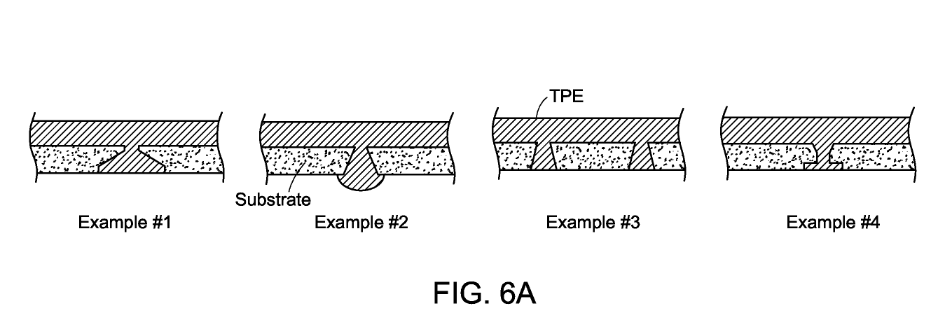

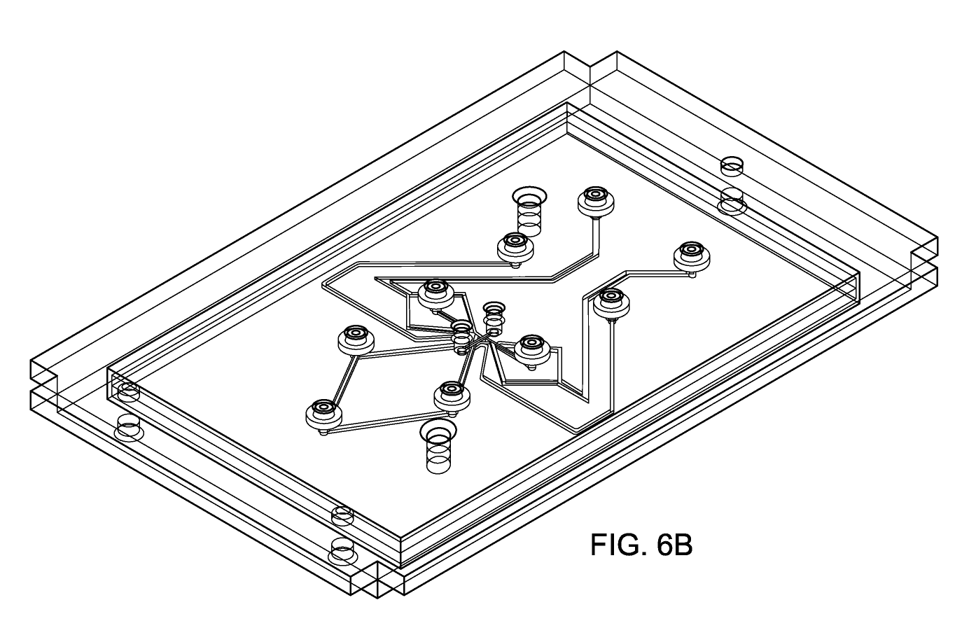

In Configuration 2, the microfluidic chip includes a top plate and a bottom plate that are bonded together, as described in Configuration 1. However, the gasket is overmolded directly onto the top plate of the microfluidic chip (see. for example, FIGS. 6A and 6B), instead of being separately injection molded. As such, no separate chip/gasket assembly step is required. The chip/gasket assembly is then fixed to a plastic carrier by a clamp (2 piece carrier), or by heat-staking or gluing (1 piece carrier).

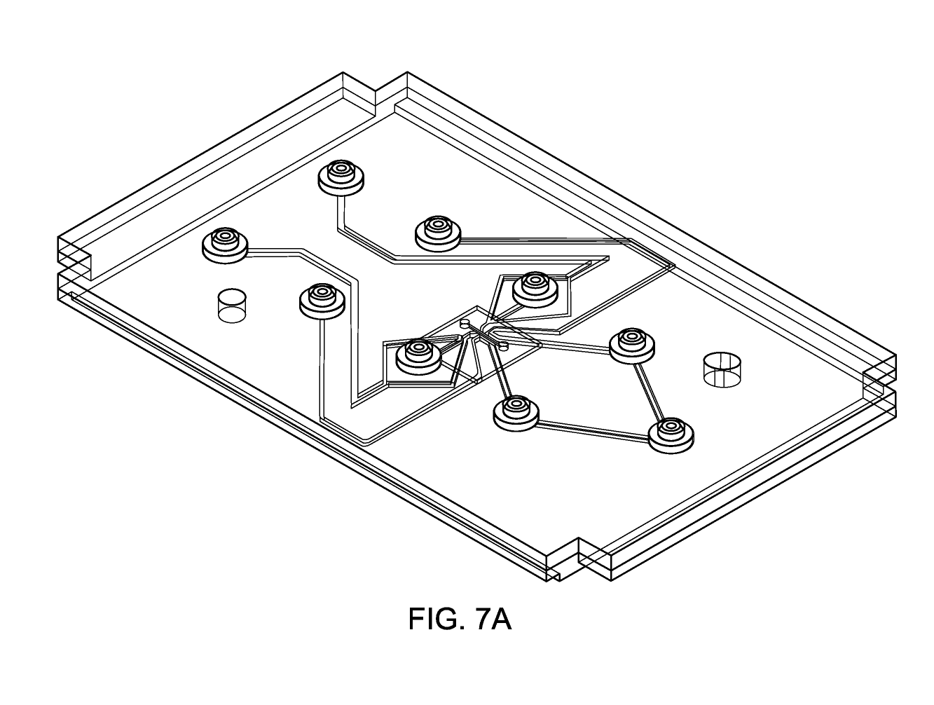

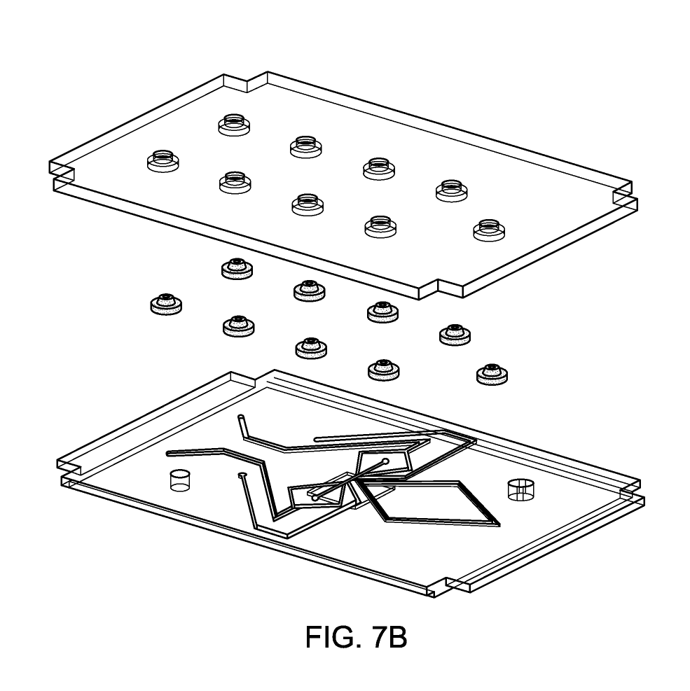

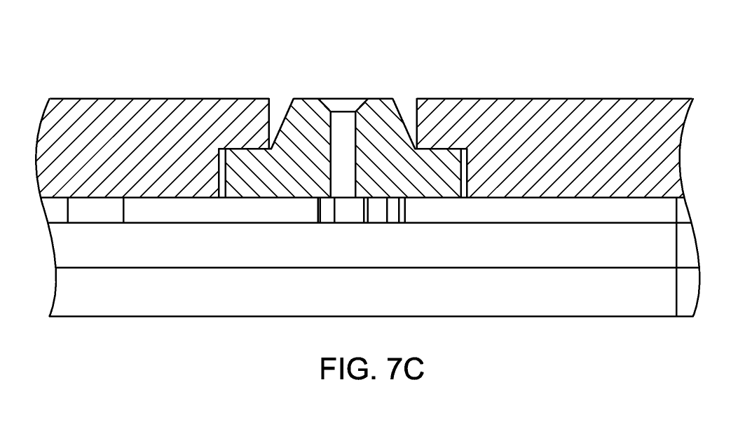

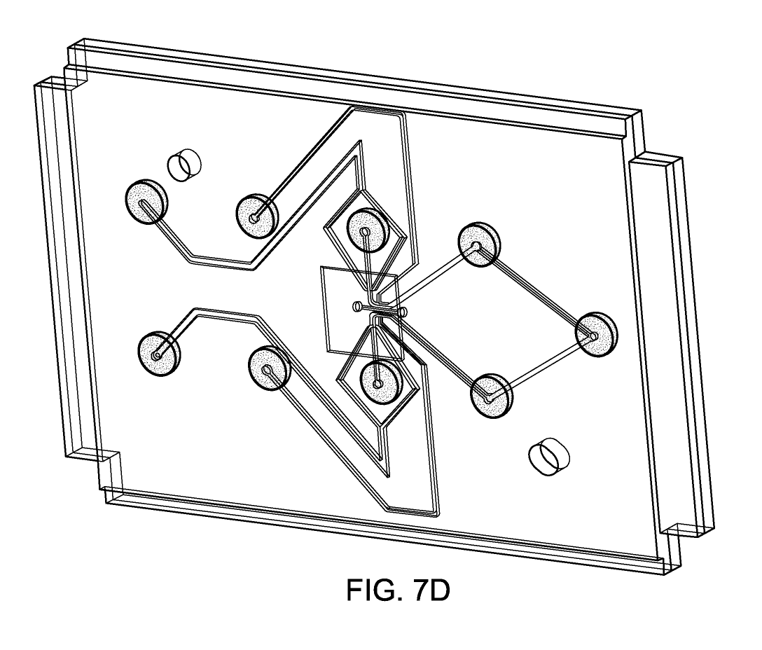

In Configuration 3, the microfluidic chip includes a top plate and a bottom plate, as described in Configuration 1. The top plate has pockets for gaskets to be molded into it. The gaskets are placed into the top plate prior to bonding the top and bottom plate together, for example by heat sealing (see FIGS. 7A-7D). In this configuration, the gasket is contained within the chip, and the carrier features are designed into the top and bottom plate. In other words, the chip itself is the carrier. A separate plastic carrier is not necessary. As such, Configuration 3 has an overall decreased thickness as compared to Configurations which utilize a plastic carrier, such as those described in Configurations 1 and 2. Other features can be designed into the chip to protect sensitive areas, such as an imaging FOV.

Configuration 4 is similar to Configuration 3, except that the chip/gasket assembly is fixed to a plastic carrier.

The gasket can be made of a variety of materials of different durometers. Preferably, the gasket is made of a material that is compatible for use with water and oil-based fluids, and in particular, a fluorinated oil. Suitable materials include elastomeric materials having a hardness, shore A ranging from 20.0-75.0, preferably 30.0-60.0, more preferably 40.0 to 55.0, a processing temperature ranging from 300° F. to 500° F., a feed temperature of about 80°-100° F., a mold temperature ranging from 60° F. to 105° F., and an injection pressure ranging from 250 psi to 7500 psi. In particular embodiments, the gasket is made of a thermoplastic silicone elastomer, such as Geniomer® 200 Silicone TPE (Wacker Chemie), which is a two phase block copolymer made up of a soft polydimethylsiloxane (PDMS) phase and a hard aliphatic isocyanate phase. On account of its structure and the high siloxane content (over 90%), the material is highly flexible and combines excellent transparency with good mechanical properties. Geniomer® 200 contains neither plasticizers nor reinforcing fillers. It can be processed using standard thermoplastic processing techniques, and is particularly suitable for injection molding because of its low melt viscosity. Such materials are capable resisting flaking and degradation in the presence of a fluorinated oil, and/or after sealingly receiving a means for introducing a sample fluid (e.g., a tubing or pipette)

The microfluidic chip can be injection molded from a variety of materials. Preferably the microfluidic chip is injection molded using a cyclic olefin copolymer (COC).

The microfluidic chip and gasket interface can be injection molded as individual components that are assembled together. Alternatively, the gasket interface can be overmolded directly onto the fluidic plate. For example, the gasket interface can be overmolded onto the entire surface of the fluid plate, with tapered bosses aligned with the port modules within the fluid plate, or the gasket interface can be overmolded within each individual port module within the fluid plate.

The plastic carrier and clamp can also be injection molded from a variety of materials. Preferably, the plastic carrier and clamp are injection molded using acrylonitrile butadiene styrene (ABS).

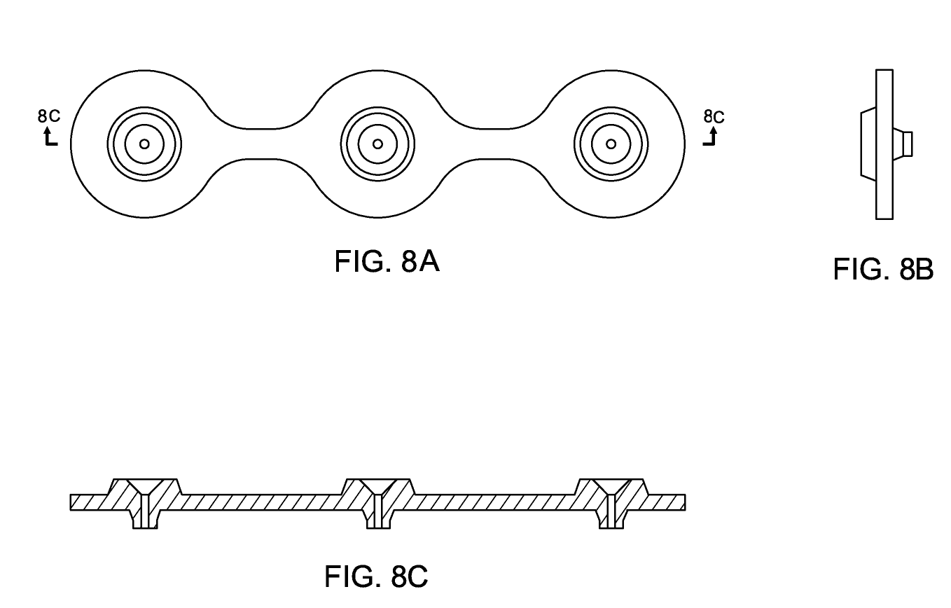

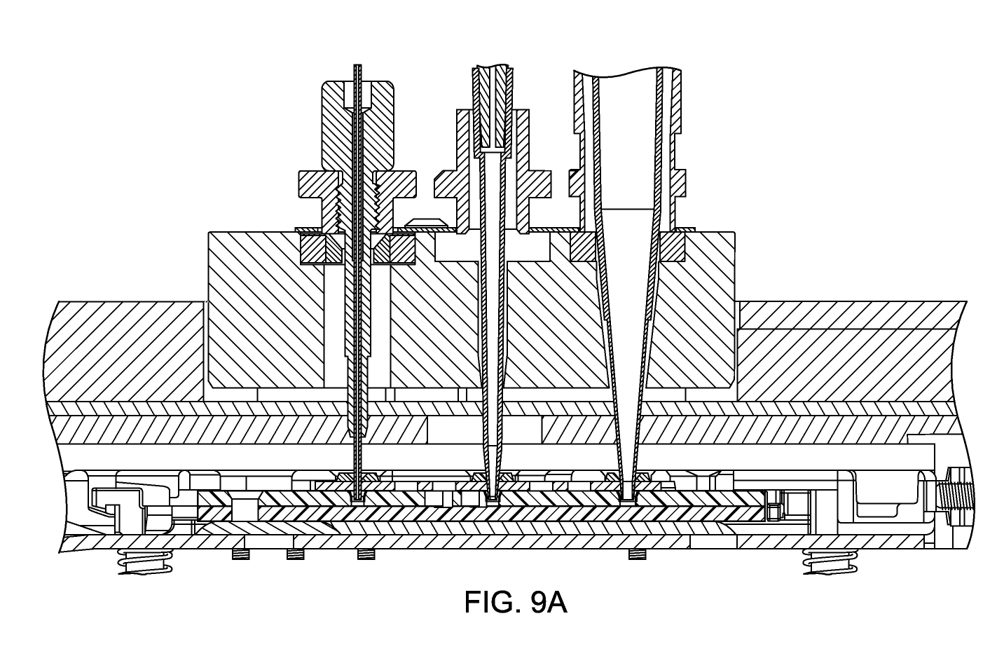

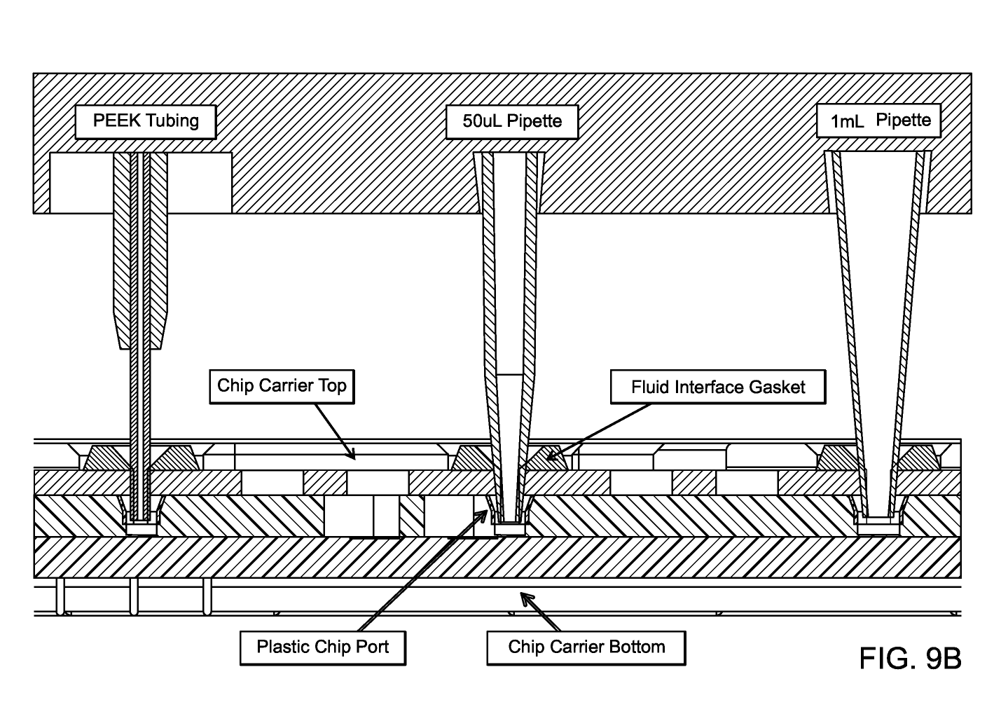

A preferred embodiment of a gasket interface for use in a microfluidic chip is depicted in FIG. 8. In this particular embodiment, the gasket is injection molded using Genomier® 200. The gasket is then assembled to a microfluidic chip having three port modules which align with the bosses on the gasket. FIGS. 9A and 9B depict the preferred embodiment of the fluid interface with a microfluidic chip using the gasket depicted in FIG. 8 is depicted in FIGS. 9A and 9B. As shown in FIGS. 9A and 9B, the gasket/chip assembly is configured to accommodate a variety of means for introducing a sample fluid, including PEEK tubing, a 50 uL pipette, and a 1 mL pipette. It should be noted that one or more of the gaskets depicted in FIG. 8 can be assembled with a microfluidic chip, so long as the chip has an appropriate number of corresponding port structures to align with the bosses on the gaskets.

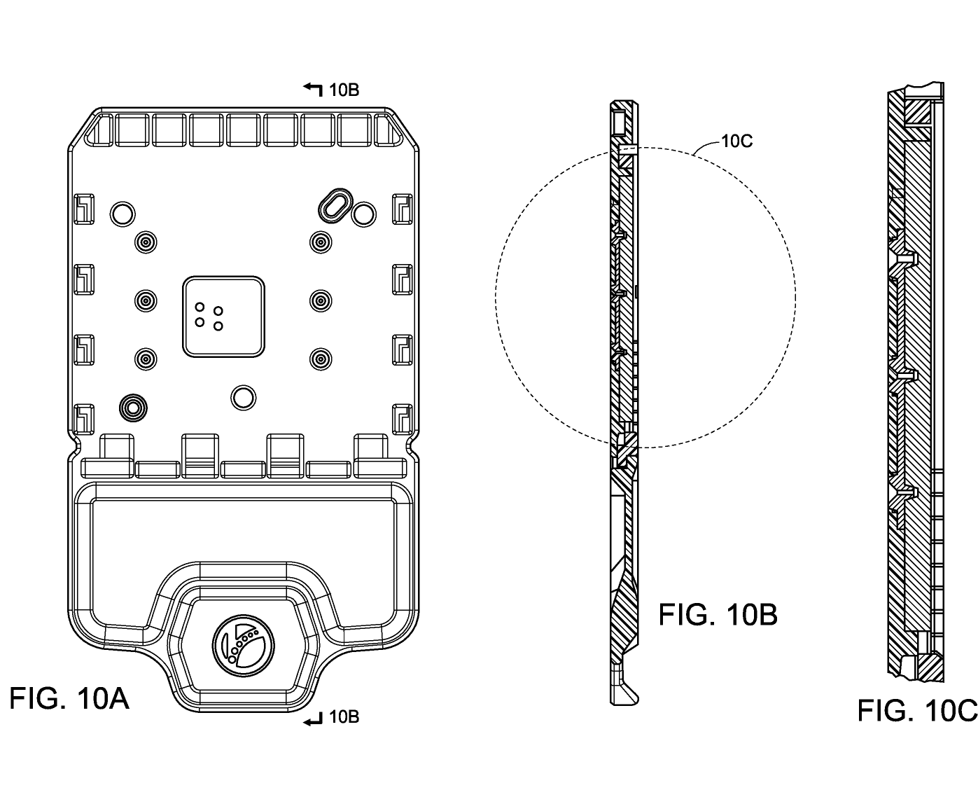

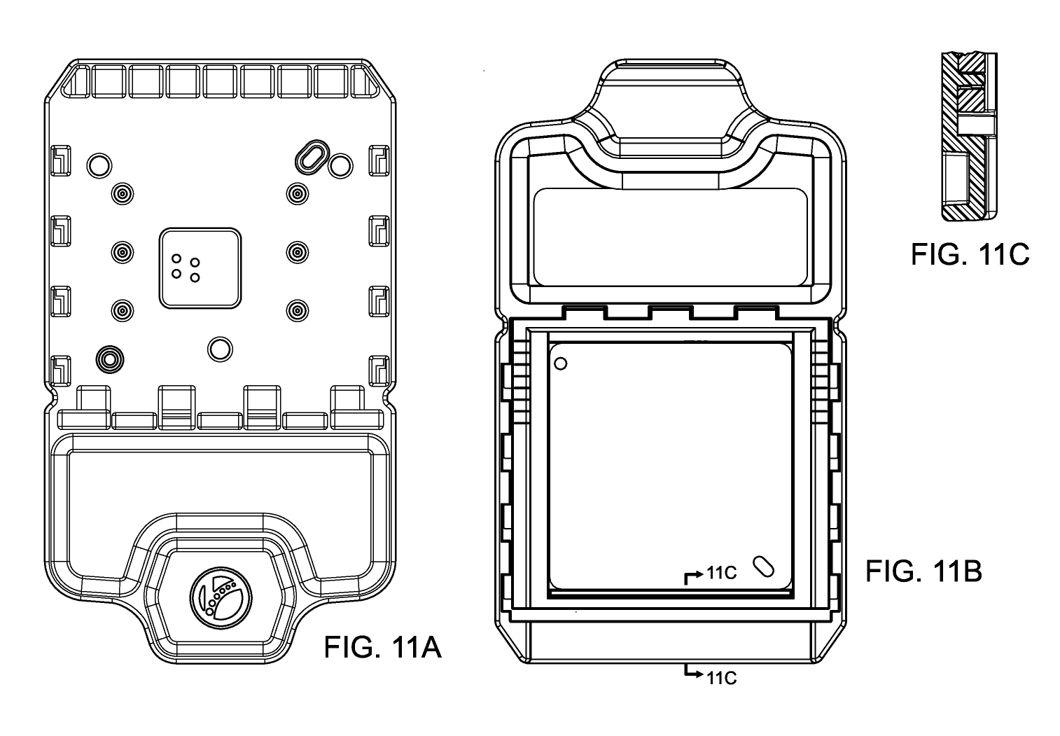

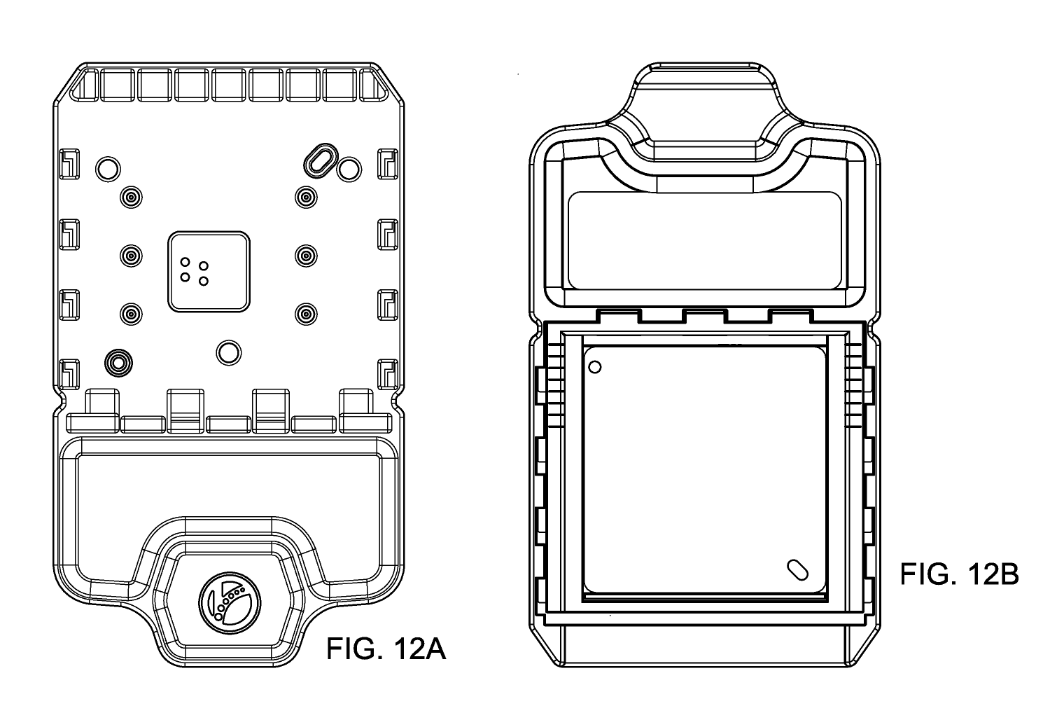

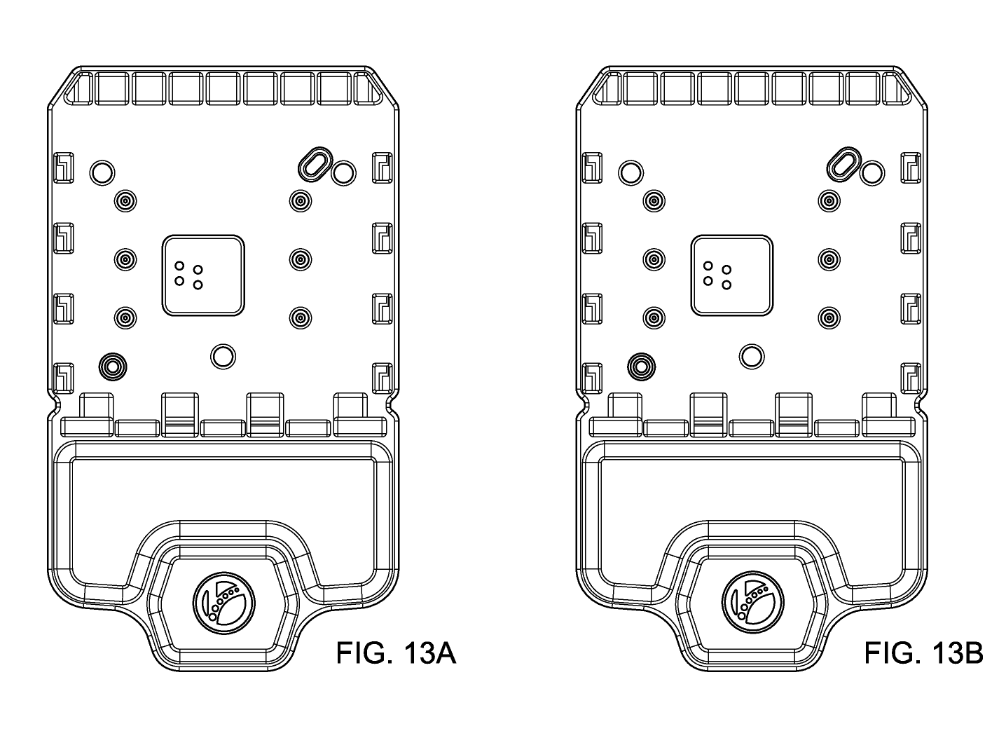

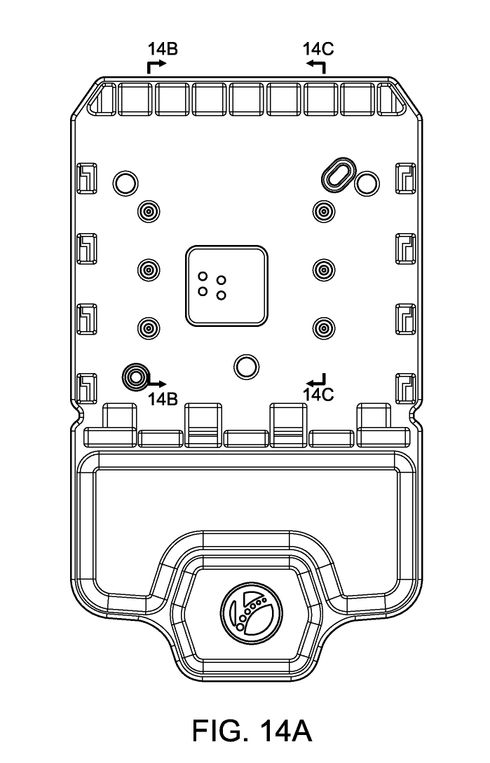

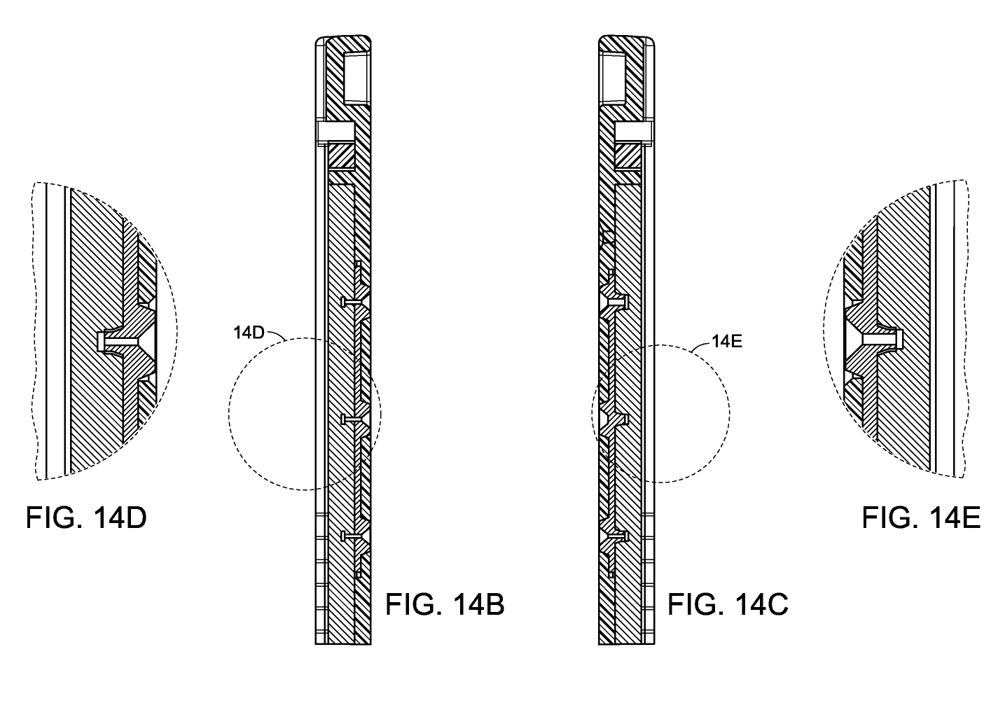

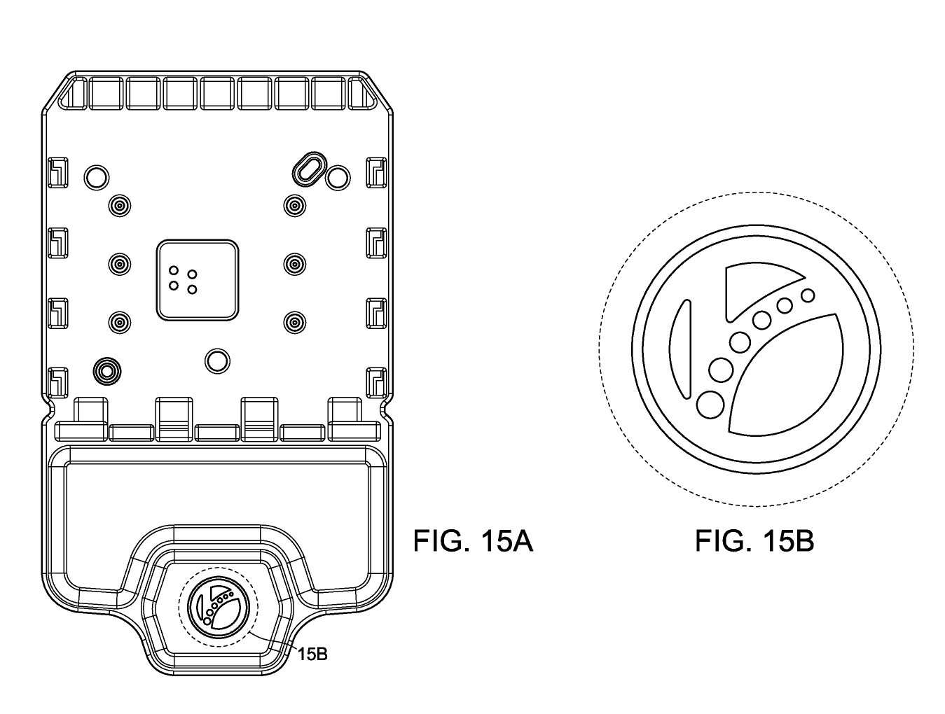

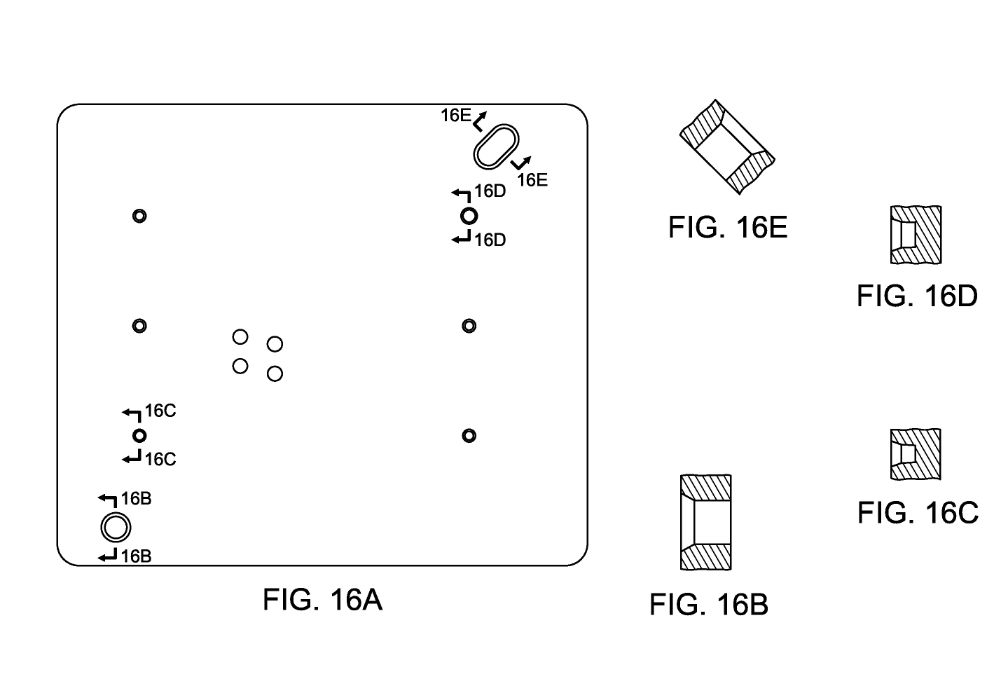

FIGS. 10-16 depict different perspective views of a preferred embodiment of a full gasket/chip/carrier assembly, which includes the gasket and the fluid interface depicted in FIGS. 8 and 9, respectively. The device depicted in FIGS. 10-16 further include a member defining at least three internal channels, each channel having an inlet port and an outlet port. The member includes a top plate adhered to a bottom plate, where each of the top and bottom plates has a top surface and a bottom surface, and where the top surface of the bottom plate faces and is adhered to the bottom surface of the top plate. The bottom plate defines the channels, while the top plate defines the ports.

In FIGS. 10-16, a first gasket is associated with the first, second, and third inlet ports and is configured to sealingly receive an input pipette or tubing such that fluid exits a tip of the input pipette or tubing and enters one of the first, second, and third channels via one of the first, second, and third inlet ports. A second gasket associated with the first, second, and third outlet ports is configured to sealingly receive an output pipette or tubing such that fluid exits one of the first, second, and third channels via one of the first, second, and third outlet ports and enters a tip of the output pipette or tubing. The first and second gaskets are each injection molded from a thermoplastic silicone elastomer, such as Genomier® 200.

The first gasket includes a first bottom portion that fits at least partially into the first inlet port, a second bottom portion that fits at least partially into the second inlet port, and a third bottom portion that fits at least partially into the third inlet port. The first gasket further includes a first, second and third top portion that sealingly receives the input pipette to allow fluid that exits the tip of the input pipette to enter the first, second and third channels, respectively.

The second gasket includes a first, a second and a third bottom portion that fits at least partially into the first, second and third outlet ports, respectively. The second gasket further includes a first, a second and a third top portion that sealingly receives the output pipette or tube to allow fluid that exits the first, second and third channels to enter the output pipette or tube.

It is noted that the assembly depicted in FIGS. 10-16 corresponds to Configuration 1 described in Table 1 above, using a 2 piece plastic carrier that includes a bar code label as a means for identifying the sample fluid and/or experiment being conducted within the microfluidic chip.

A disposable cartridge for use with a microfluidic analysis system is also provided herein. The disposable cartridge includes a carrier and a microfluidic device disposed within the carrier, such as the microfluidic device described and depicted in FIGS. 10-16. For example, the microfluidic device includes a member defining at least three internal channels and also defining a first inlet port and a first outlet port of a first one of the channels, a second inlet port and a second outlet port of a second one of the channels, and a third inlet port and a third outlet port of a third one of the channels. A first gasket is associated with the first, second, and third inlet ports and configured to sealingly receive an input pipette such that fluid exits a tip of the input pipette and enters one of the first, second, and third channels via one of the first, second, and third inlet ports. A second gasket associated with the first, second, and third outlet ports and configured to sealingly receive an output pipette such that fluid exits one of the first, second, and third channels via one of the first, second, and third outlet ports and enters a tip of the output pipette.

Microfluidic chips are generally designed as a single-use, disposable chip, to avoid cross-contamination in biological, chemical and diagnostic assays. The gasket interfaces described herein can be disposable with the chip to avoid cross-contamination. Unlike previous fluid interface designs for pressure-driven microfluidic systems in which manufacturing of the interface can be complicated and expensive (e.g., Luer-Loc systems in which connection requires a twisting motion), the elastomeric gaskets described herein can be injection molded and are easily assembled with a microfluidic chip, or can be overmolded directly onto the microfluidic chip.

### Methods for Molding Fluidic Interconnects Directly on the Substrate

The present invention also provides methods of direct molding of fluidic interconnects into a microfluidic device. Development of a commercial microfluidic platform requires a simple, reliable fluidic interconnect in order to reduce the chance of operator error and leaks. Molding these interconnects directly into the microfluidic device requires precise alignment of the molding pins to the patterned shim (the “master” manufactured from Silicon/photoresist or made from some metal) used to form the microfluidic and electrical channels. The extreme tolerances required when molding with a low viscosity elastomer such as PDMS requires near perfect sealing of the pin face to the master, while still accommodating imperfections in the master and assembly of the molding tool. In an embodiment, the present invention provides a precise and repeatable method of molding of interconnects while accommodating the imperfections in the molding process by introducing movable pins captured in an elastomeric sleeve molded directly into the tool. In order to effectively produce at relatively low volume and be able to inexpensively prototype devices, the tool must be able to use masters generated using standard photolithographic processes (e.g. silicon wafers patterned with SU-8).

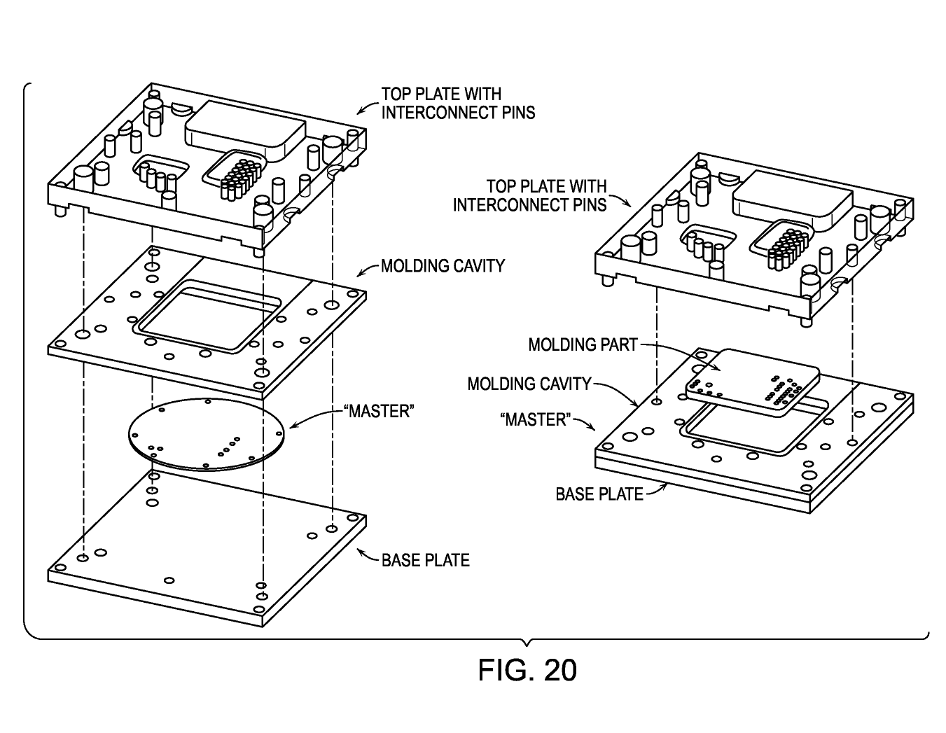

FIG. 20 shows a schematic of a molding tool based on this concept. In FIG. 20, the pins are captured within an elastomeric molded sleeve. A compression plate made from a rigid backer plate and foam rubber is used to apply gentle even pressure to the pins and generate the force needed to make the pins uniformly contact the master. The molded sleeve was found to be necessary to consistently prevent the uncured elastomer from penetrating the region between the pin and the top plate. Early designs used pins captured in tight clearance holes, and the pins would frequently bind in place (even with lubricant), preventing smooth motion of the pins and improper contact with the master. This would in turn cause a thin film of the elastomer to form between the bottom of the pin and the master (“Flash”). This flash prevents proper operation of the interconnects during chip operation. The addition of the elastomeric sleeves around each pin eliminated this problem, and produce consistent, reliable shutoff between the master and the pins.

### Electrodes

The device can include channels for use in fluid control and other channels filled with a metal alloy for casting integrated metal alloy components (i.e., electrodes). Alternatively, the electrodes can be manufactured using other technologies (e.g., lithographically patterned electrodes made from indium tin oxide or a metal such as platinum). The microfluidic device can include metal alloy components useful for performing electrical functions on fluids, including but not limited to, coalescing droplets, charging droplets, sorting droplets, detecting droplets and shaking droplets to mix the contents of coalesced droplets. The device can contain more than one of the above mentioned components for more than one of the above mentioned functions.

The electrodes comprising metal alloy components may either terminate at fluid channels or be isolated from fluid channels. The electrodes can be constructed by filling the appropriate channels with metal alloy. One way this can be accomplished is to use positive pressure injection of the metal alloy in a melted state, such as with a syringe, into the channels, and then cool the metal alloy to a solid form. Another example is to use negative pressure to draw the metal alloy in a melted state into the channels, and then cool the metal alloy to a solid form. This can be accomplished for example by use of capillary forces. Another method of construction can use any of the above mentioned embodiments, and then flush out the metal alloy in a melted state with another liquid to define the geometry of the metal alloy components. Another example is to use any of the above mentioned embodiments, and then use a localized cold probe to define a solid termination point for the metal alloy, and then cool the remaining metal alloy to a solid form. A further example is to use another material, such as microscopic solder spheres or UV curable conductive ink, to form a barrier between fluid and metal alloy channels, to define the geometry of the metal alloy components.

The device can include a combination of both integrated metal alloy components and a patterned electrically conductive layer. The patterned electrically conductive layer can have features patterned such that their boundaries are within a leak-proof seal. The device can have a patterned electrically conductive feature as one of two charging electrodes and one integrated metal alloy component as the other of two charging electrodes.

The device can include a plurality of electrodes that are insulated from the fluid present in the device, and the method of operation including appropriate application of dielectrical signals and appropriate fluids. In known devices, the electrodes are typically in contact with the fluids in order to allow discharge of species that would otherwise screen the applied dielectric field. Whereas, in devices where the electrodes have been insulated from the fluid, this screening effect typically arises so quickly that the device is not useful for any significantly extended period of time. The drawbacks of electrodes in contact with the fluids vs. insulated electrodes are (a) degraded reliability against leaking (since the interface between the electrodes and the other components of the device may be more difficult to effect a leak-proof seal), and (b) degraded reliability against electrode corrosion (whose failure mode effects include failure of application of dielectric fields, and fluid channel contamination).

The device of the present invention comprising a plurality of electrodes that are insulated from the fluid present in the device counteracts this screening effect by extending the screening rise time and including a polarity switch for all of the different dielectric fields applied in the device. The screening rise time is extended by using fluids with dielectrical properties. A polarity switch for all of the different dielectric fields applied in the device is achieved by using an algorithm for dielectrical control, which switches the polarity of the dielectrical fields at a frequency sufficiently high to maintain proper dielectrical function of the device. This dielectrical control algorithm may also switch the polarity for the dielectric fields in a cascading, time controlled manner starting at the fluid origin point and progressing downstream, so that given fluid components experience one polarity at every point along their course. The device of the present invention can be used with metal alloy electrodes or using a combination of metal alloy electrodes and patterned conductive film electrodes.

The invention can provide a microfluidic device using injected electrodes. The interface between the microscopic electrode (typically 25 μm thick) and the macroscopic interconnect can easily fail if the joint between the two is flexed. The flexing of the joint can be eliminated by securing a firm material that serves to fasten, support, and re-enforce the joint (i.e., a grommet) into the interface. In order to prevent flexing, the mating surface of the device can be manufactured from a hard material such as glass or plastic. The electrical connection with the external system can be made by securing the device such that it connects to a spring loaded contact, which is either offset from the grommet (thereby minimizing the force applied to the solder region), or centered on the grommet (as long as the contact does not touch the solder).

The metal alloy components are also useful for performing optical functions on fluids, including but not limited to, optical detection of droplets in a geometry which may include a mirror.

To prevent leakage of fluid out of electrodes placed within microfluidic channels, the microfluidic device can include a layer patterned with channels for fluid control, and another layer with patterned electrically conductive features, where the features are patterned such that their boundaries are within a leak-proof seal. The leak-proof seal can be achieved at the interface between the unpatterned areas of the fluid control layer and the unpatterned areas of the electrically conductive layer. The leak-proof seal can also be achieved by a third interfacial layer between the fluid control layer and the unpatterned areas of the electrically conductive layer. The third interfacial layer can or cannot be perforated at specific locations to allow contact between the fluid and the electrically conductive layer. Electrical access ports can also be patterned in the fluid control layer.

The electrodes and patterned electrically conductive layers as described can be associated with any module of the device as described herein to generate dielectric or electric forces to manipulate and control the droplets and their contents.

Effective control of uncharged droplets within microfluidic devices can require the generation of extremely strong dielectric field gradients. The fringe fields from the edges of a parallel plate capacitor can provide an excellent topology to form these gradients. The microfluidic device according to the present invention can include placing a fluidic channel between two parallel electrodes, which can result in a steep electric field gradient at the entrance to the electrodes due to edge effects at the ends of the electrode pair. Placing these pairs of electrodes at a symmetric channel split can allow precise bi-directional control of droplet within a device. Using the same principle, only with asymmetric splits, can allow single ended control of the droplet direction in the same manner. Alternatively, a variation on this geometry will allow precise control of the droplet phase by shifting.

In some cases, transparent or substantially transparent electrodes can be used. The electric field generator can be constructed and arranged (e.g., positioned) to create an electric field applicable to the fluid of at least about 0.01 V/micrometer, and, in some cases, at least about 0.03 V/micrometer, at least about 0.05 V/micrometer, at least about 0.08 V/micrometer, at least about 0.1 V/micrometer, at least about 0.3 V/micrometer, at least about 0.5 V/micrometer, at least about 0.7 V/micrometer, at least about 1 V/micrometer, at least about 1.2 V/micrometer, at least about 1.4 V/micrometer, at least about 1.6 V/micrometer, or at least about 2 V/micrometer. In some embodiments, even higher electric field intensities may be used, for example, at least about 2 V/micrometer, at least about 3 V/micrometer, at least about 5 V/micrometer, at least about 7 V/micrometer, or at least about 10 V/micrometer or more.

As described, an electric field may be applied to fluidic droplets to cause the droplets to experience an electric force. The electric force exerted on the fluidic droplets may be, in some cases, at least about 10⁻¹⁶ N/μm³. In certain cases, the electric force exerted on the fluidic droplets may be greater, e.g., at least about 10⁻¹⁵ N/μm³, at least about 10⁻¹⁴ N/μm³, at least about 10⁻¹³ N/μm³, at least about 10⁻¹² N/μm³, at least about 10⁻¹¹ N/μm³, at least about 10⁻¹⁰N/μm³, at least about 10⁻⁹N/μm³, at least about 10⁻⁸ N/μm³, or at least about 10⁻⁷ N/μm³ or more. The electric force exerted on the fluidic droplets, relative to the surface area of the fluid, may be at least about 10⁻¹⁵ N/μm², and in some cases, at least about 10⁻¹⁴ N/μm², at least about 10⁻¹³ N/μm², at least about 10⁻¹² N/μm², at least about 10⁻¹¹ N/μm², at least about 10⁻¹⁰ N/μm², at least about 10⁻⁹ N/μm², at least about 10⁻⁸ N/μm², at least about 10⁻⁷ N/μm², or at least about 10⁻⁶ N/μm² or more. In yet other embodiments, the electric force exerted on the fluidic droplets may be at least about 10⁻⁹N, at least about 10⁻⁸N, at least about 10⁻⁷N, at least about 10⁻⁶ N, at least about 10⁻⁵N, or at least about 10⁻⁴N or more in some cases.

### Coalescence Module

The microfluidic device of the present invention also includes one or more coalescence modules. A “coalescence module” is within or coincident with at least a portion of the main channel at or downstream of the inlet module where molecules, cells, small molecules or particles comprised within droplets are brought within proximity of other droplets comprising molecules, cells, small molecules or particles and where the droplets in proximity fuse, coalesce or combine their contents. The coalescence module can also include an apparatus, for generating an electric force.

The electric force exerted on the fluidic droplet may be large enough to cause the droplet to move within the liquid. In some cases, the electric force exerted on the fluidic droplet may be used to direct a desired motion of the droplet within the liquid, for example, to or within a channel or a microfluidic channel (e.g., as further described herein), etc.

The electric field can be generated from an electric field generator, i.e., a device or system able to create an electric field that can be applied to the fluid. The electric field generator may produce an AC field (i.e., one that varies periodically with respect to time, for example, sinusoidally, sawtooth, square, etc.), a DC field (i.e., one that is constant with respect to time), a pulsed field, etc. The electric field generator may be constructed and arranged to create an electric field within a fluid contained within a channel or a microfluidic channel. The electric field generator may be integral to or separate from the fluidic system containing the channel or microfluidic channel, according to some embodiments. As used herein, “integral” means that portions of the components integral to each other are joined in such a way that the components cannot be in manually separated from each other without cutting or breaking at least one of the components.

Techniques for producing a suitable electric field (which may be AC, DC, etc.) are known to those of ordinary skill in the art. For example, in one embodiment, an electric field is produced by applying voltage across a pair of electrodes, which may be positioned on or embedded within the fluidic system (for example, within a substrate defining the channel or microfluidic channel), and/or positioned proximate the fluid such that at least a portion of the electric field interacts with the fluid. The electrodes can be fashioned from any suitable electrode material or materials known to those of ordinary skill in the art, including, but not limited to, silver, gold, copper, carbon, platinum, copper, tungsten, tin, cadmium, nickel, indium tin oxide (“ITO”), etc., as well as combinations thereof.

### Detection Module

The microfluidic device of the present invention can also include one or more detection modules. A “detection module” is a location within the device, typically within the main channel where molecules, cells, small molecules or particles are to be detected, identified, measured or interrogated on the basis of at least one predetermined characteristic. The molecules, cells, small molecules or particles can be examined one at a time, and the characteristic is detected or measured optically, for example, by testing for the presence or amount of a reporter. For example, the detection module is in communication with one or more detection apparatuses. The detection apparatuses can be optical or electrical detectors or combinations thereof. Examples of suitable detection apparatuses include optical waveguides, microscopes, diodes, light stimulating devices, (e.g., lasers), photo multiplier tubes, and processors (e.g., computers and software), and combinations thereof, which cooperate to detect a signal representative of a characteristic, marker, or reporter, and to determine and direct the measurement or the sorting action at the sorting module. However, other detection techniques can also be employed

The term “determining,” as used herein, generally refers to the analysis or measurement of a species, for example, quantitatively or qualitatively, and/or the detection of the presence or absence of the species. “Determining” may also refer to the analysis or measurement of an interaction between two or more species, for example, quantitatively or qualitatively, or by detecting the presence or absence of the interaction. Examples of suitable techniques include, but are not limited to, spectroscopy such as infrared, absorption, fluorescence, UV/visible, FTIR (“Fourier Transform Infrared Spectroscopy”), or Raman; gravimetric techniques; ellipsometry; piezoelectric measurements; immunoassays; electrochemical measurements; optical measurements such as optical density measurements; circular dichroism; light scattering measurements such as quasielectric light scattering; polarimetry; refractometry; or turbidity measurements as described further herein.

A detection module is within, communicating or coincident with a portion of the main channel at or downstream of the inlet module and, in sorting embodiments, at, proximate to, or upstream of, the sorting module or branch point. The sorting module may be located immediately downstream of the detection module or it may be separated by a suitable distance consistent with the size of the molecules, the channel dimensions and the detection system. Precise boundaries for the detection module are not required, but are preferred.

Detection modules used for detecting molecules and cells have a cross-sectional area large enough to allow a desired molecule, cells, bead, or particles to pass through without being substantially slowed down relative to the flow carrying it. The dimensions of the detection module are influenced by the nature of the sample under study and, in particular, by the size of the droplets, beads, particles, molecules or cells (including virions) under study. For example, mammalian cells can have a diameter of about 1 to 50 microns, more typically 10 to 30 microns, although some mammalian cells (e.g., fat cells) can be larger than 120 microns. Plant cells are generally 10 to 100 microns. However, other molecules or particles can be smaller with a diameter from about 20 nm to about 500 nm.

### Mixing Module

The microfluidic device of the present invention can further include one or more mixing modules. Although coalescence of one or more droplets in one or more coalescence modules can be sufficient to mix the contents of the coalesced droplets (e.g., through rotating vortexes existing within the droplet), it should be noted that when two droplets fuse or coalesce, perfect mixing within the droplet does not instantaneously occur. Instead, for example, the coalesced droplet may initially be formed of a first fluid region (from the first droplet) and a second fluid region (from the second droplet). Thus, in some cases, the fluid regions may remain as separate regions, for example, due to internal “counter-revolutionary” flow within the fluidic droplet, thus resulting in a non-uniform fluidic droplet. A “mixing module” can comprise features for shaking or otherwise manipulate droplets so as to mix their contents. The mixing module is preferably downstream from the coalescing module and upstream from the detection module. The mixing module can include, but is not limited to, the use of channel geometries, acoustic actuators, metal alloy component electrodes or electrically conductive patterned electrodes to mix the contents of droplets and to reduce mixing times for fluids combined into a single droplet in the microfluidic device. For example, the fluidic droplet may be passed through one or more channels or other systems which cause the droplet to change its velocity and/or direction of movement. The change of direction may alter convection patterns within the droplet, causing the fluids to be at least partially mixed. Combinations are also possible.

For acoustic manipulation, the frequency of the acoustic wave should be fine-tuned so as not to cause any damage to the cells. The biological effects of acoustic mixing have been well studied (e.g., in the ink-jet industry) and many published literatures also showed that piezoelectric microfluidic device can deliver intact biological payloads such as live microorganisms and DNA. In an example, the design of the acoustic resonant uses a Piezoelectric bimorph flat plate located on the side of the carved resonant in the PDMS slab. The piezoelectric driving waveform is carefully optimized to select the critical frequencies that can separate cells in fluids. There are five parameters to optimize beyond the frequency parameter. Lab electronics is used to optimize the piezoelectric driving waveform. Afterwards, a low cost circuit can be designed to generate only the optimized waveform in a preferred microfluidic device.

The frequency of the acoustic wave should be fine-tuned so as not to cause any damage to the cells. The biological effects of acoustic mixing have been well studied (e.g., in the ink-jet industry) and many published literatures also showed that piezoelectric microfluidic device can deliver intact biological payloads such as live microorganisms and DNA.

### Sensors

One or more detections sensors and/or processors may be positioned to be in sensing communication with the fluidic droplet. “Sensing communication,” as used herein, means that the sensor may be positioned anywhere such that the fluidic droplet within the fluidic system (e.g., within a channel), and/or a portion of the fluidic system containing the fluidic droplet may be sensed and/or determined in some fashion. For example, the sensor may be in sensing communication with the fluidic droplet and/or the portion of the fluidic system containing the fluidic droplet fluidly, optically or visually, thermally, pneumatically, electronically, or the like. The sensor can be positioned proximate the fluidic system, for example, embedded within or integrally connected to a wall of a channel, or positioned separately from the fluidic system but with physical, electrical, and/or optical communication with the fluidic system so as to be able to sense and/or determine the fluidic droplet and/or a portion of the fluidic system containing the fluidic droplet (e.g., a channel or a microchannel, a liquid containing the fluidic droplet, etc.). For example, a sensor may be free of any physical connection with a channel containing a droplet, but may be positioned so as to detect electromagnetic radiation arising from the droplet or the fluidic system, such as infrared, ultraviolet, or visible light. The electromagnetic radiation may be produced by the droplet, and/or may arise from other portions of the fluidic system (or externally of the fluidic system) and interact with the fluidic droplet and/or the portion of the fluidic system containing the fluidic droplet in such as a manner as to indicate one or more characteristics of the fluidic droplet, for example, through absorption, reflection, diffraction, refraction, fluorescence, phosphorescence, changes in polarity, phase changes, changes with respect to time, etc. As an example, a laser may be directed towards the fluidic droplet and/or the liquid surrounding the fluidic droplet, and the fluorescence of the fluidic droplet and/or the surrounding liquid may be determined. “Sensing communication,” as used herein may also be direct or indirect. As an example, light from the fluidic droplet may be directed to a sensor, or directed first through a fiber optic system, a waveguide, etc., before being directed to a sensor.

Non-limiting examples of detection sensors useful in the invention include optical or electromagnetically-based systems. For example, the sensor may be a fluorescence sensor (e.g., stimulated by a laser), a microscopy system (which may include a camera or other recording device), or the like. As another example, the sensor may be an electronic sensor, e.g., a sensor able to determine an electric field or other electrical characteristic. For example, the sensor may detect capacitance, inductance, etc., of a fluidic droplet and/or the portion of the fluidic system containing the fluidic droplet. In some cases, the sensor may be connected to a processor, which in turn, cause an operation to be performed on the fluidic droplet, for example, by sorting the droplet.

### Processors

As used herein, a “processor” or a “microprocessor” is any component or device able to receive a signal from one or more sensors, store the signal, and/or direct one or more responses (e.g., as described above), for example, by using a mathematical formula or an electronic or computational circuit. The signal may be any suitable signal indicative of the environmental factor determined by the sensor, for example a pneumatic signal, an electronic signal, an optical signal, a mechanical signal, etc.

The device of the present invention can comprise features, such as integrated metal alloy components and/or features patterned in an electrically conductive layer, for detecting droplets by broadcasting a signal around a droplet and picking up an electrical signal in proximity to the droplet.

### Methods

The microfluidic devices of the present invention can be utilized to conduct numerous chemical and biological assays, including but not limited to, creating emulsion libraries, flow cytometry, gene amplification, isothermal gene amplification, DNA sequencing, SNP analysis, drug screening, RNAi analysis, karyotyping, creating microbial strains with improved biomass conversion, moving cells using optical tweezer/cell trapping, transformation of cells by electroporation, .mu.TAS, and DNA hybridization.

### DEFINITIONS

The terms used in this specification generally have their ordinary meanings in the art, within the context of this invention and in the specific context where each term is used. Certain terms are discussed below, or elsewhere in the specification, to provide additional guidance to the practitioner in describing the devices and methods of the invention and how to make and use them. It will be appreciated that the same thing can typically be described in more than one way. Consequently, alternative language and synonyms may be used for any one or more of the terms discussed herein. Synonyms for certain terms are provided. However, a recital of one or more synonyms does not exclude the use of other synonyms, nor is any special significance to be placed upon whether or not a term is elaborated or discussed herein. All publications, patent applications, patents, and other references mentioned herein are incorporated by reference. In the case of conflict, the present specification, including definitions, will control. In addition, the materials and methods described herein are illustrative only and are not intended to be limiting.

As used herein, “about” or “approximately” shall generally mean within 20 percent, preferably within 10 percent, and more preferably within 5 percent of a given value or range.

The term “molecule” means any distinct or distinguishable structural unit of matter comprising one or more atoms, and includes for example polypeptides and polynucleotides.

The term “polymer” means any substance or compound that is composed of two or more building blocks (‘mers’) that are repetitively linked to each other. For example, a “dimer” is a compound in which two building blocks have been joined together.

The term “polynucleotide” as used herein refers to a polymeric molecule having a backbone that supports bases capable of hydrogen bonding to typical polynucleotides, where the polymer backbone presents the bases in a manner to permit such hydrogen bonding in a sequence specific fashion between the polymeric molecule and a typical polynucleotide (e.g., single-stranded DNA). Such bases are typically inosine, adenosine, guanosine, cytosine, uracil and thymidine. Polymeric molecules include double and single stranded RNA and DNA, and backbone modifications thereof, for example, methylphosphonate linkages.

Thus, a “polynucleotide” or “nucleotide sequence” is a series of nucleotide bases (also called “nucleotides”) generally in DNA and RNA, and means any chain of two or more nucleotides. A nucleotide sequence typically carries genetic information, including the information used by cellular machinery to make proteins and enzymes. These terms include double or single stranded genomic and cDNA, RNA, any synthetic and genetically manipulated polynucleotide, and both sense and anti-sense polynucleotide (although only sense stands are being represented herein). This includes single- and double-stranded molecules, i.e., DNA-DNA, DNA-RNA and RNA-RNA hybrids, as well as “protein nucleic acids” (PNA) formed by conjugating bases to an amino acid backbone. This also includes nucleic acids containing modified bases, for example thio-uracil, thio-guanine and fluoro-uracil.

The polynucleotides herein may be flanked by natural regulatory sequences, or may be associated with heterologous sequences, including promoters, enhancers, response elements, signal sequences, polyadenylation sequences, introns, 5′- and 3′-non-coding regions, and the like. The nucleic acids may also be modified by many means known in the art. Non-limiting examples of such modifications include methylation, “caps”, substitution of one or more of the naturally occurring nucleotides with an analog, and internucleotide modifications such as, for example, those with uncharged linkages (e.g., methyl phosphonates, phosphotriesters, phosphoroamidates, carbamates, etc.) and with charged linkages (e.g., phosphorothioates, phosphorodithioates, etc.). Polynucleotides may contain one or more additional covalently linked moieties, such as, for example, proteins (e.g., nucleases, toxins, antibodies, signal peptides, poly-L-lysine, etc.), intercalators (e.g., acridine, psoralen, etc.), chelators (e.g., metals, radioactive metals, iron, oxidative metals, etc.), and alkylators. The polynucleotides may be derivatized by formation of a methyl or ethyl phosphotriester or an alkyl phosphoramidate linkage. Furthermore, the polynucleotides herein may also be modified with a label capable of providing a detectable signal, either directly or indirectly. Exemplary labels include radioisotopes, fluorescent molecules, biotin, and the like.

The term “dielectrophoretic force gradient” means a dielectrophoretic force is exerted on an object in an electric field provided that the object has a different dielectric constant than the surrounding media. This force can either pull the object into the region of larger field or push it out of the region of larger field. The force is attractive or repulsive depending respectively on whether the object or the surrounding media has the larger dielectric constant.

“DNA” (deoxyribonucleic acid) means any chain or sequence of the chemical building blocks adenine (A), guanine (G), cytosine (C) and thymine (T), called nucleotide bases, that are linked together on a deoxyribose sugar backbone. DNA can have one strand of nucleotide bases, or two complimentary strands which may form a double helix structure. “RNA” (ribonucleic acid) means any chain or sequence of the chemical building blocks adenine (A), guanine (G), cytosine (C) and uracil (U), called nucleotide bases, that are linked together on a ribose sugar backbone. RNA typically has one strand of nucleotide bases.

A “polypeptide” (one or more peptides) is a chain of chemical building blocks called amino acids that are linked together by chemical bonds called peptide bonds. A “protein” is a polypeptide produced by a living organism. A protein or polypeptide may be “native” or “wild-type”, meaning that it occurs in nature; or it may be a “mutant”, “variant” or “modified”, meaning that it has been made, altered, derived, or is in some way different or changed from a native protein, or from another mutant.

As used herein, “particles” means any substance that may be encapsulated within a droplet for analysis, reaction, sorting, or any operation according to the invention. Particles are not only objects such as microscopic beads (e.g., chromatographic and fluorescent beads), latex, glass, silica or paramagnetic beads, but also includes other encapsulating porous and/or biomaterials such as liposomes, vesicles and other emulsions. Beads ranging in size from 0.1 micron to 1 mm can be used in the devices and methods of the invention and are therefore encompassed with the term “particle” as used herein. The term particle also encompasses biological cells, as well as beads and other microscopic objects of similar size (e.g., from about 0.1 to 120 microns, and typically from about 1 to 50 microns) or smaller (e.g., from about 0.1 to 150 nm). The devices and methods of the invention are also directed to sorting and/or analyzing molecules of any kind, including polynucleotides, polypeptides and proteins (including enzymes) and their substrates and small molecules (organic or inorganic). Thus, the term particle further encompasses these materials.

The particles (including, e.g., cells and molecules) are sorted and/or analyzed by encapsulating the particles into individual droplets (e.g., droplets of aqueous solution in oil), and these droplets are then sorted, combined and/or analyzed in a microfabricated device. Accordingly, the term “droplet” generally includes anything that is or can be contained within a droplet.

A “small molecule” as used herein, is meant to refer to a composition that has a molecular weight of less than about 5 kD and most preferably less than about 4 kD. Small molecules can be, e.g., nucleic acids, peptides, polypeptides, peptidomimetics, carbohydrates, lipids or other organic or inorganic molecules. Libraries of chemical and/or biological mixtures, such as fungal, bacterial, or algal extracts, are known in the art.

As used herein, “cell” means any cell or cells, as well as viruses or any other particles having a microscopic size, e.g. a size that is similar to or smaller than that of a biological cell, and includes any prokaryotic or eukaryotic cell, e.g., bacteria, fungi, plant and animal cells. Cells are typically spherical, but can also be elongated, flattened, deformable and asymmetrical, i.e., non-spherical. The size or diameter of a cell typically ranges from about 0.1 to 120 microns, and typically is from about 1 to 50 microns. A cell may be living or dead. Since the microfabricated device of the invention is directed to sorting materials having a size similar to a biological cell (e.g. about 0.1 to 120 microns) or smaller (e.g., about 0.1 to 150 nm) any material having a size similar to or smaller than a biological cell can be characterized and sorted using the microfabricated device of the invention. Thus, the term cell shall further include microscopic beads (such as chromatographic and fluorescent beads), liposomes, emulsions, or any other encapsulating biomaterials and porous materials. Non-limiting examples include latex, glass, or paramagnetic beads; and vesicles such as emulsions and liposomes, and other porous materials such as silica beads. Beads ranging in size from 0.1 micron to 1 mm can also be used, for example in sorting a library of compounds produced by combinatorial chemistry. As used herein, a cell may be charged or uncharged. For example, charged beads may be used to facilitate flow or detection, or as a reporter. Biological cells, living or dead, may be charged for example by using a surfactant, such as SDS (sodium dodecyl sulfate). The term cell further encompasses “virions”, whether or not virions are expressly mentioned.

A “virion”, “virus particle” is the complete particle of a virus. Viruses typically comprise a nucleic acid core (comprising DNA or RNA) and, in certain viruses, a protein coat or “capsid”. Certain viruses may have an outer protein covering called an “envelope”. A virion may be either living (i.e., “viable”) or dead (i.e., “non-viable”). A living or “viable” virus is one capable of infecting a living cell. Viruses are generally smaller than biological cells and typically range in size from about 20-25 nm diameter or less (parvoviridae, picornoviridae) to approximately 200-450 nm (poxyiridae). However, some filamentous viruses may reach lengths of 2000 nm (closterviruses) and are therefore larger than some bacterial cells. Since the microfabricated device of the invention is particularly suited for sorting materials having a size similar to a virus (i.e., about 0.1 to 150 nm), any material having a size similar to a virion can be characterized and sorted using the microfabricated device of the invention. Non-limiting examples include latex, glass or paramagnetic beads; vesicles such as emulsions and liposomes; and other porous materials such as silica beads. Beads ranging in size from 0.1 to 150 nm can also be used, for example, in sorting a library of compounds produced by combinatorial chemistry. As used herein, a virion may be charged or uncharged. For example, charged beads may be used to facilitate flow or detection, or as a reporter. Biological viruses, whether viable or non-viable, may be charged, for example, by using a surfactant, such as SDS.

A “reporter” is any molecule, or a portion thereof, that is detectable, or measurable, for example, by optical detection. In addition, the reporter associates with a molecule, cell or virion or with a particular marker or characteristic of the molecule, cell or virion, or is itself detectable to permit identification of the molecule, cell or virion's, or the presence or absence of a characteristic of the molecule, cell or virion. In the case of molecules such as polynucleotides such characteristics include size, molecular weight, the presence or absence of particular constituents or moieties (such as particular nucleotide sequences or restrictions sites). In the case of cells, characteristics which may be marked by a reporter includes antibodies, proteins and sugar moieties, receptors, polynucleotides, and fragments thereof. The term “label” can be used interchangeably with “reporter”. The reporter is typically a dye, fluorescent, ultraviolet, or chemiluminescent agent, chromophore, or radio-label, any of which may be detected with or without some kind of stimulatory event, e.g., fluoresce with or without a reagent. In one embodiment, the reporter is a protein that is optically detectable without a device, e.g. a laser, to stimulate the reporter, such as horseradish peroxidase (HRP). A protein reporter can be expressed in the cell that is to be detected, and such expression may be indicative of the presence of the protein or it can indicate the presence of another protein that may or may not be coexpressed with the reporter. A reporter may also include any substance on or in a cell that causes a detectable reaction, for example by acting as a starting material, reactant or a catalyst for a reaction which produces a detectable product. Cells may be sorted, for example, based on the presence of the substance, or on the ability of the cell to produce the detectable product when the reporter substance is provided.

A “marker” is a characteristic of a molecule, cell or virion that is detectable or is made detectable by a reporter, or which may be coexpressed with a reporter. For molecules, a marker can be particular constituents or moieties, such as restrictions sites or particular nucleic acid sequences in the case of polynucleotides. For cells and virions, characteristics may include a protein, including enzyme, receptor and ligand proteins, saccharides, polynucleotides, and combinations thereof, or any biological material associated with a cell or virion. The product of an enzymatic reaction may also be used as a marker. The marker may be directly or indirectly associated with the reporter or can itself be a reporter. Thus, a marker is generally a distinguishing feature of a molecule, cell or virion, and a reporter is generally an agent which directly or indirectly identifies or permits measurement of a marker. These terms may, however, be used interchangeably.

Certain embodiments according to the invention have been disclosed. These embodiments are illustrative of, and not limiting on, the invention. Other embodiments, as well as various modifications and combinations of the disclosed embodiments, are possible and within the scope of the disclosure.

What is claimed is:

1. A microfluidic device, comprising:
a member defining at least one internal channel and at least one port in fluid communication with each of the channels; and
a gasket associated with each of the ports and configured to sealingly receive a fluid transport mechanism such that said fluid exits the transport mechanism and enters one of the channels, the gasket comprising an elastomeric material comprised of a two phase block copolymer having a soft polydimethylsiloxane phase and a hard aliphatic isocyanate phase.

2. The microfluidic device of claim 1 wherein the elastomeric material comprises approximately 90% siloxane or greater.

3. The microfluidic device of claim 1 wherein the gasket is formed by injection molding.

4. The microfluidic device of claim 1 wherein the gasket comprises Genomier® 200.

5. The microfluidic device of claim 1 wherein the gasket is compatible with a fluorinated oil.

6. The microfluidic device of claim 1 wherein the gasket resists flaking and degradation after sealingly receiving the fluid transport mechanism.

7. The microfluidic device of claim 1 wherein a portion of the gasket fits at least partially into the port and another portion of the gasket sealingly receives the fluid transport mechanism.

8. The microfluidic device of claim 1 wherein the member comprises a top plate adhered to a bottom plate.

9. The microfluidic device of claim 8 wherein each of the top and bottom plates has a top surface and a bottom surface, and wherein the top surface of the bottom plate faces and is adhered to the bottom surface of the top plate.

10. The microfluidic device of claim 9 wherein the bottom plate defines the channels and the top plate defines the ports.

11. The microfluidic device of claim 1, wherein the fluid transport mechanism is a pipette or a tube.

12. A microfluidic device, comprising:
a member defining at least three internal channels and also defining a first inlet port and a first outlet port of a first one of the channels, a second inlet port and a second outlet port of a second one of the channels, and a third inlet port and a third outlet port of a third one of the channels;
a first gasket associated with the first, second, and third inlet ports and configured to sealingly receive a fluid input mechanism such that fluid exits the fluid input mechanism and enters one of the first, second, and third channels via one of the first, second, and third inlet ports; and
a second gasket associated with the first, second, and third outlet ports and configured to sealingly receive a fluid output mechanism such that fluid exits one of the first, second, and third channels via one of the first, second, and third outlet ports and enters the fluid output mechanism,
wherein each of the first and second gaskets comprise an elastomeric material comprised of a two phase block copolymer having a soft polydimethylsiloxane phase and a hard aliphatic isocyanate phase.

13. The microfluidic device of claim 12, wherein the fluid input mechanism is a pipette or a tubing.

14. The microfluidic device of claim 13, wherein the fluid output mechanism is a pipette or a tubing.

15. The microfluidic device of claim 12 wherein each of the first and second gaskets comprises a thermoplastic silicone elastomer.

16. The microfluidic device of claim 15 wherein each of the first and second gaskets is formed by injection molding.

17. The microfluidic device of claim 15 wherein the elastomeric material comprises approximately 90% siloxane or greater.

18. The microfluidic device of claim 12 wherein each of the first and second gaskets is compatible with a fluorinated oil.

19. The microfluidic device of claim 12 wherein each of the first and second gaskets resists flaking and degradation after sealingly receiving the fluid input and fluid output mechanisms, respectively.

20. The microfluidic device of claim 12 wherein the first gasket includes a first bottom portion that fits at least partially into the first inlet port, a second bottom portion that fits at least partially into the second inlet port, and a third bottom portion that fits at least partially into the third inlet port.

21. The microfluidic device of claim 20 wherein the first gasket includes a first top portion that sealingly receives the fluid input mechanism to allow fluid that exits the fluid input mechanism to enter the first channel, a second top portion that sealingly receives the fluid input mechanism to allow fluid that exits the fluid input mechanism to enter the second channel, and a third top portion that sealingly receives the fluid input mechanism to allow fluid that exits the fluid input mechanism to enter the third channel.

22. The microfluidic device of claim 12 wherein the second gasket includes a first bottom portion that fits at least partially into the first outlet port, a second bottom portion that fits at least partially into the second outlet port, and a third bottom portion that fits at least partially into the third outlet port.

23. The microfluidic device of claim 22 wherein the second gasket includes a first top portion that sealingly receives the fluid output mechanism to allow fluid that exits the first channel to enter the fluid output mechanism, a second top portion that sealingly receives the fluid output mechanism to allow fluid that exits the second channel to enter the fluid output mechanism, and a third top portion that sealingly receives the fluid output mechanism to allow fluid that exits the third channel to enter the fluid output mechanism.

24. The microfluidic device of claim 12 wherein the member comprises a top plate adhered to a bottom plate.

25. The microfluidic device of claim 24 wherein each of the top and bottom plates has a top surface and a bottom surface, and wherein the top surface of the bottom plate faces and is adhered to the bottom surface of the top plate.

26. The microfluidic device of claim 25 wherein the bottom plate defines the channels and the top plate defines the ports.

27. The microfluidic device of claim 12 further comprising a carrier into which the microfluidic device is disposed.

28. A disposable cartridge for use with a microfluidic analysis system, comprising:
a carrier; and
a microfluidic device disposed within the carrier and comprising:
a member defining at least three internal channels and also defining a first inlet port and a first outlet port of a first one of the channels, a second inlet port and a second outlet port of a second one of the channels, and a third inlet port and a third outlet port of a third one of the channels;
a first gasket associated with the first, second, and third inlet ports and configured to sealingly receive an input pipette such that fluid exits a tip of the input pipette and enters one of the first, second, and third channels via one of the first, second, and third inlet ports; and
a second gasket associated with the first, second, and third outlet ports and configured to sealingly receive an output pipette such that fluid exits one of the first, second, and third channels via one of the first, second, and third outlet ports and enters a tip of the output pipette,
wherein each of the first and second gaskets comprise an elastomeric material comprised of a two phase block copolymer having a soft polydimethylsiloxane phase and a hard aliphatic isocyanate phase.
